(19) United States
(12) Patent Application Publication
(10) Pub. No.: US 2002/0077929 A1
(43) Pub. Date: Jun. 20, 2002

(54) Event driven shopping method utilizing electronic e-commerce order pending

(76) Inventors: Yolanda Denise Knorr, Minneapolis, MN (US); Erich Conrad Steinbergs, Minneapolis, MN (US)

Correspondence Address: Thomas L. McMasters, Fredrikson & Byron, P.A., 1100 International Centre, 900 Second Avenue South, Minneapolis, MN, 55402-3397, US

(21) Appl. No.: 09/848,960

(22) Filed: May 4, 2001

Related U.S. Application Data
(60) Provisional application No. 60/202,332, filed on May 5, 2000.

(51) Int. Cl. G06F 17/60

(52) U.S. Cl. 705/26

(57) ABSTRACT

Methods and systems for electronically pending orders for items that can be selected from online catalogs owned by e-vendors whose primary order entry, procurement and fulfillment systems are driven by industry standard real time and immediate order fulfillment processes. The present invention provides methods and systems for selecting items in the present for future fulfillment and delivery to a specific recipient for a specific event or occasion, but requiring no further involvement from the purchaser once the initial transaction has been created at some time prior to the desired fulfillment date. In one method, items are selected for pending, and transaction information obtained, while the purchaser is browsing from approved affiliated e-vendors' electronic catalogs. The pended transaction identifier information can be stored in an order pending database and subsequently monitored until pre-defined actions get scheduled for execution. The transaction identifier information can be used to place orders with the parent e-vendor at a time just prior to the requested delivery date as prescribed by the fulfillment criteria of that specific e-vendor to ensure timely shipment of the item as requested by the originating purchaser.

### RELATED APPLICATIONS

The present application claims priority to United States Provisional Patent Application entitled Event Driven Shopping Method, filed on May 5, 2000, Serial No. 60/202,332, herein incorporated by reference in its entirety.

### FIELD OF THE INVENTION

The present invention is related generally to methods of doing business and electronic commerce in e-retail and mass marketing environments. More specifically, the present invention is related to methods and systems for electronically creating and managing pended orders. The present invention includes methods and systems whereby end users may select catalogued items from one or multiple e-vendors for immediate entry into an order pending database, for later transmission to an electronic vendor.

### BACKGROUND OF THE INVENTION

Shopping from home or from remote locations has long been a staple of retail commerce. The Sears-Roebuck® catalog, for example, made shopping from home common in the United States. In particular, shopping from home for annual occasions like Christmas has become a common occurrence now that direct marketing has broadened from a catalog base to a more electronic web-based modality. The Internet has made shopping easy and convenient. The Internet and its associated web-based marketing venues are well known, requiring no further discussion here. Examples of methods for doing business over computer networks and the Internet may be found in U.S. Pat. Nos. 5,960,411; 5,715,314; 5,825,651; and 5,745,681, all herein incorporated by reference. Consumers may presently purchase products and services from electronic vendors through utilization of procurement systems located at remote sites that are connected via a web based connection. One example of such an electronic vendor is Amazon.com®, which frequently receives orders for books and other items over the Internet from consumers who choose to shop electronically.

Despite the increase in web-based shopping, there are nonetheless many more browsers than there are actual buyers on the World Wide Web. So even a small increase in the number of consumers who make and act on a purchase decision can provide significant advantage to an electronic vendor. In one example, Amazon.com has provided “one click” shopping as a way to make it more convenient for shoppers to complete purchase transactions. This one click shopping method allows shoppers to initiate the purchase of an item with a single mouse click, thereby converting, or reversibly converting, a browser click into a purchase. Even this seemingly small advantage can provide significantly increased revenue to an electronic retailer.

With the increase in two-career households and the acceleration of modem life, many consumers lack the time to travel to malls or other “brick-and-mortar” establishments to shop. When the time is found, the scheduled delivery date, such as a birthday, may have passed. In many cases, the inability to find a convenient time to shop and prepare for events like birthdays or Mother's Day can result in a special event or occasion arriving with the consumer being out of time to recognize the occasions as they would have liked. Similarly, electronic shoppers are often too rushed to respond as they would ideally like for special events like annual holidays or birthdays, and don't have a convenient way to plan ahead for occasions they would like to recognize, even though they know that those occasions are coming up.

Electronic vendors have sought to increase the “stickiness” of their electronic retail sites, by encouraging their shoppers to draw a strong correlation between the products and services they have to offer and the consumers' need to have a very reliable. predictable, fast, and easy way to shop and buy for periodic events like birthdays or holidays. This is why most e-retail vendors have gifting centers or “wish-list” services imbedded in their websites. If successful in creating a fulfilling event or occasion specific shopping experience once, there is great likelihood that the consumer will return to that e-vendor the next time he needs to shop for that same “sticky” event or occasion, such as a birthday or annual holiday.

What would be advantageous, are methods and systems for turning browsers into buyers, especially if they are buyers who are pre-disposed to buy for predictable and re-occurring or recurring events or transactions. It would further be beneficial to both consumers and e-vendors alike to provide methods and systems for ensuring that purchases for special events or occasions are completed and managed so that time appropriate execution is easy to achieve, even without the consumer's involvement at the time of optimal execution. Electronic commerce sites would benefit from methods and systems for turning an occasional browser into a recurrent, periodic purchaser.

### SUMMARY OF THE INVENTION

The present invention is related generally to methods of doing business and electronic commerce in e-retail and mass marketing environments. More specifically, the present invention is related to methods and systems for electronically creating and managing pended orders that would ordinarily be processed using industry standard e-commerce fulfillment methods that typically initiate fulfillment and shipping immediately once an end user places and confirms an order. Herein, the process of creating a pended or pendant order may be referred to as “pending” an order, i.e., “to pend,” the order then being “pended.” The present invention enables end users to create and confirm orders (which also refers to a transaction generally, and is also referred to generally herein as transactions) that can be specifically initiated for the purpose of fulfillment at a future date as prescribed by the end user. The end user can provide a specific set of fulfillment instructions for the specific purpose of having those instructions managed and executed at some future date without the end user having to re-engage in the transaction in order for that transaction to be executed, shipped, and fulfilled at that specified future date. The present invention includes methods and systems whereby end users, (referred to herein generally as purchasers,) may select catalogtied items from one or multiple e-vendors for immediate entry into an order pending database, for later transmission to an electronic vendor, who is typically the owner of the electronic catalog from which the end user has selected for future fulfillment.

As used herein, the terms “order pending system” and “electronic order pending system” refer to the method, process or approach for electronically capturing data elements in order to identify, isolate, manage, pend and execute transactions that are preferably initiated at least three weeks prior to the desired fulfillment date of that transaction. As used herein, the terms “vendor,” “electronic vendor,” “affiliated vendor,” affiliated e-vendor,” “retailer,” “electronic retailer,” “e-tailer,” “purchasing system,” and “procurement system” include such entities and systems that initially present electronic catalogs of products and services to be browsed and selected for purchase, and that will also receive ultimate payment for the items once shipped. The affiliated e-vendor is typically the catalog owner as well as the fulfillment source for items presented in their catalog. The affiliated vendor may alternately assign catalog ownership or fulfillment of their catalog items to other vendors, in which case the order pending system interacts with the third-party vendor as an authorized agent for the parent e-vendor, with due regard and sensitivity for the brand integrity and brand identity of the parent or third-party vendor and licensees. As used herein, the term “parent vendor” refers to the affiliated third-party e-vendor from whose electronic catalog a specific item has been selected for future fulfillment. In one embodiment of the present invention, the interface with third-party vendors, undertaken with due care to their brand identity, may permit cooperative or complementary relationships among and between various third-party vendors, particularly where those vendors do not compete directly in the marketplace, but may jointly take advantage of synergies between their respective marketing spheres.

In addition to affiliated parent vendors, the present invention is well-suited to web-based malls, by which a purchaser may select products from vendors whose portal access is managed by a third-party who provides access and services associated with transactions executed with those vendors. If a web-based mall or portal owner implements the order pending system for its purchasers, the web-based or mall portal owner may wish to manage directly the order pending process, or may wish to assign that management responsibility to a third-party system administrator or ASP.

The term “item” may herein refer generally to the product or service that is available for selection by a purchaser. In a preferred embodiment, the item is given from the purchaser to a specific recipient for a specific purpose, event, or occasion. As used herein, the term “purchaser” refers to a consumer who initiates the transaction to be pended, and agrees to pay for the ultimate fulfillment of all the items identified in that transaction. “Purchaser,” thus, may refer to, and may be described variously herein, as a consumer, buyer, subscriber, customer, or transaction owner. The term “event” or “occasion” may herein refer generally to any specified scheduled future date that has been assigned for the purpose of identifying when a transaction should be delivered and complete, and may be a date that is established for a unique purpose of assigning a scheduled delivery date, or may be a date that is generally associated with widely-known occasions like holidays or birthdays.

The present invention provides methods and systems for purchasers to select items on a current date for the purpose of having the transaction completed and fulfilled at a future date, preferably anywhere from at a time beyond what is considered real-time, contemporaneous, or traditional “immediate execution of process” order, fulfillment, and delivery. According to the current invention, delivery may be effected at any time, for example, 3 weeks or 12 months later. Items from catalogs of one or more electronic vendors may be selected, marked for future fulfillment, and placed in a pending queue for future payment and execution with specific instructions on when, where, and to whom the items are to be delivered. This described order pending method is comprised of a system having a set of application-based routines, data management software applications and servers. This system delivers the electronic pending function through a series of interactions between schedulers, dispatchers, and inbound and outbound manager and router communications protocols, which can monitor, query, and execute each individual transaction to drive time-sensitive routines that manage a pended transaction from inception to completion in accordance with instructions from the electronic vendors and the purchaser and/or recipient. Purchaser information that is collected as a result of the process may give rise to marketing opportunities, with due regard given to purchaser choice and privacy, particularly with respect to minors, and where privacy laws so dictate.

As the fulfillment date for a particular transaction approaches, the electronic order pending system can retrieve the transaction identifier information (including item identifiers, recipient identifiers, fulfillment instructions, and the billing information) from the order pending database, and dispatch that information to one or more electronic vendors for verification, confirmation, and fulfillment in accordance with a predetermined time that will support the items being delivered on the requested delivery date, such as a birthday, special occasion, or any date or event, as defined by the purchaser. The electronic vendor(s) may then ship the items to the recipient and bill the purchaser who owns or initiated the transaction. In other embodiments, the administrator of the order pending system itself is the immediate purchaser to the e-vendor, with the initial purchaser having previously paid for the item(s) through a remittance to the Application Service Provider or administrator/host of the order pending system. The electronic order pending method's transaction identifiers can include event or occasion identifiers and profiles (such profiles can include names, dates, recipients, reminder preferences, or fulfillment preferences pertaining to an event or occasion); recipient identifiers and profiles (recipient profiles can include name, nicknames, address(es) and associated special occasion dates); purchaser identifiers and profiles (purchaser profiles can include name, addresses, credit card, and fulfillment preferences); vendor identifier profiles (vendor profiles can include name, vendor system parameters, order fulfillment schedule requirements, peak period special instructions, and promotional preferences); and one or more item identifiers and profiles (item profiles can include parent vendor identifiers, item number, price, size, color, availability, and complementary, or “suggestion” item identifiers). A compilation of some or all of these identifiers can combine to create a transaction identifier and profile (the transaction profile can include all of the above information about a transaction that is queued and awaiting fulfillment and execution by the electronic order pending system).

The event or occasion identifier and profile can be a single occurrence event such as a graduation, wedding or anticipated birth. The event can also be periodically re-occurring, e.g. annually, such as a birthday, anniversary, or annual holiday like Mother's Day, Valentine's Day, Christmas, Sukkot, Chanukkah, Eid Al-Fitr, Children's Day, a country's national or patriotic day, e.g. El16 de septiembre or Cinco de mayo, or the like. The event identifier may typically be an event's date or a commonly known holiday name. The event or occasion can also be one that is uniquely defined by the purchaser to appropriately identify and assign an event name to any transaction even if it is not a widely-known event, such as “Joe's House Warming.” The event or occasion identifier information can be obtained from a purchaser's direct input into the electronic order pending system or from an approved or affiliated third-party database to which the purchaser has access.

The recipient identifier and profile can include the recipient's name, nicknames, address(es), phone, gender, age, and relation to the purchaser. The recipient identifier information can be obtained from a purchaser's direct input, or from an approved third-party database to which the purchaser has access.

The vendor identifier and profile can include, for example, vendor's name, nicknames, address(es), telephone number(s), SIC code, description, URL(s), type, status, lead time days (required for timely shipment), cut-off days, peak periods, billing cycle, credit terms, and financial institution information. The vendor identifier information can be obtained from a vendor's direct input, or by the direct input of an administrator of the order pending system. Alternatively, the vendor identifier information may be supplied via a third party database, or through the establishment of an EDI relationship with the vendor.

The item identifier and profile can include the parent e-vendor name (i.e., that vendor who owns the catalog description of the item that has been selected and the rights to fill orders or designate the fulfillment entity for that unique selected item, item description or name, parent e-vendor catalog number, item brand name, price, color, size, and any other information that is normally carried in an e-vendor's catalog profile. The item identifier information can be obtained electronically via the purchaser selecting and clicking on items from the parent vendor's catalog or a designated subset of that catalog. Details about the item can be transferred from the electronic catalog into the order pending database and all the relevant transaction profiles. The item identifier information may also be transferred into a file or data structure which may be termed a “Personalized Browse Cart,” which holds the item identifier information in a non-transactional repository so that the purchaser may retrieve it and associate it with any particular transaction at a later date, e.g., to order that same item for multiple or other transactions the purchaser wishes to create.

The purchaser identifier profile may include the purchaser name, address(es), phone number, and some indicia of payment. Indicia of payment may include, for example, credit card numbers, checking account numbers, intermediary electronic payment means or services having access to the credit card numbers or checking account numbers, or electronic equivalents of cash. The purchaser profile may also include information on the purchaser's preferences about reminders, shipping preferences, and related databases which the purchaser wishes the order pending system to access so that recipient infonration can be sent or received.

The transaction identifier and profile can contain all information gathered from the event profiles, recipient profiles, vendor profiles, item profiles and purchaser profiles, and can be tied to a specific event for a specific recipient and a specific purchaser. The transaction profile can be compiled and set in the order pending database to act as the source of any routines that the scheduler and dispatcher execute in order to process a transaction. The transaction can be set up as a recurring transaction where the same event, item, vendor, recipient and purchaser information is used to create duplicate transactions to be fulfilled sequentially or periodically, such as the same transaction every Valentine's Day or the same monthly order for office supplies. This may be distinguished from a re-occurring transaction, i.e., an order may be associated with a recurring delivery date, and a transaction may include instructions either to make that transaction a recurring transaction to be repeated in its entirety, including the item specifications, at the specified interval or period. Alternatively, the item may vary in some respect, e.g quantity, per period or recurrence of the event, i.e., a re-occurring transaction.

In addition to the transaction identifier elements, the electronic order pending method may include other system elements necessary to execute the electronic order pending functions including an order pending database and its related data stores, scheduler, dispatcher, and router systems. These system elements may reside in a server-based software stack which may be maintained apart from the parent electronic vendors' procurement and fulfillment systems and servers. In some embodiments, the order pending database and systems can reside side-by-side at the parent vendor' location within the same physical computer or cluster of computers. The order pending database can be periodically checked by a set of scheduler routines and instructions. The scheduler can check for the imminent occurrence of required activities related to a specific transaction or set of daily routines. In one embodiment of the present invention, when an order is received, the scheduler will read the scheduled delivery date, and after calculating based on vendor lead time and shipping data, will determine one or more interim reminder or notification periods or dates (“period” herein referring to a length of time or a particular date), a verification period, item confirmation period, event billing period, order execution period, and order confirmation period as a part of the method which manages the vendor stream of routines. The scheduler may also assign required daily monitoring, system management functions, and exception management routines. On the part of the purchaser stream of routines for that transaction, the scheduler may similarly calculate an order confirmation period, interim or mid-point reminder period(s) or date(s), last chance to change or cancel reminder period, event billing period, occasion reminder period, transaction completed notification period, and recipient follow-up period.

The dispatcher can receive instructions and commands from the scheduler to retrieve and send information from the transaction which is stored in the order pending database. On or near the e-vendor' specified fulfillment date, the item identifier profile can be used to send the electronic vendor(s) the order for the items listed in the identifier profile for that specific transaction. The transaction may be entered into the order pending system weeks, months, or a year or more prior to the requested delivery date.

The electronic vendor, upon receiving the order that has been dispatched from the transaction identifier, through an outbound router, and to the electronic vendor, can receive requests for item verifications, confirmation, and on the optimum date, requests to fulfill the order according to their standard real-time fulfillment system processes. The e-vendor may then validate and confirm that the item order can be filled as requested, or alternately, flag an exception to the administrator of the order pending system. At the point where the item is confirmed by the e-vendor as available and ready for shipment, the order pending system can transmit a compiled bill, invoice, or charge to the purchaser for the sum total amount of all items included in that event's transaction, preferably even if the items were selected from multiple e-vendor electronic catalogs. The bill, invoice or charge can be sent to the purchaser and the assigned payer source (for example, a credit card company) as instructed in the purchaser identifier profile and payment identifier profile. The purchaser may assign multiple payor sources for the transaction so that if one fails, another can be used to effect payment.

In addition to the periodic purchasing scenario described above, the present invention can connect isolated and sporadic browsing episodes that are not tied to completed transactions into a “Personalized Browse Cart” which is another embodiment of the electronic order pending method of the present invention. The purchaser may use the “Personalized Browse Cart” to store item information from multiple affiliated e-vendors to create a personalized electronic catalog that is unique to that purchaser and that can be used as a source of making item selections for multiple transactions at any date after the item has been stored in the “Personalized Browse Cart”, and until the date when the purchaser removes the item or until such time when the parent vendor for that item flags it as no longer available. While the present invention may be implemented as an automatic non-manual process, in a preferred embodiment, human attendants are made available to assist purchasers “off-line,” e.g. via voice POTS or voice over IP during error and exception handling events which are not transparent to the purchaser.

The present invention may be implemented, in the case of third-party vendor roles, using vendor on-line catalogs, or a central catalog administered by the order pending system owner or administrator. Alternatively, the system could be implemented with an option by which purchasers may submit an order for a product without reference to a catalog, following which the order pending system administrator would locate the item, e.g, with a third-party vendor, and effect the remainder of the transaction.

### BRIEF DESCRIPTION OF THE DRAWINGS

FIG. 1 is a process flow diagram chart of a method according to the present invention;

FIG. 2 is a process flow diagram of a process according to the present invention;

FIG. 3 is a timeline process demonstrating the execution of an embodiment of the present invention;

FIG. 4 is a dataflow diagram of the batch and real-time (synchronous and asynchronous) flow of data points between the system environments of the system entities;

FIG. 5 is a network architecture and dataflow diagram of a system for obtaining transaction identifier information from a purchaser who wishes to use the order pending system;

FIG. 6 is a network architecture and dataflow diagram showing communication between the electronic order pending system and an affiliated electronic vendor's web-based catalog;

FIG. 7 is a network architecture and dataflow diagram of the dispatcher and inbound/outbound router communications to transmit and exchange order verification data;

FIG. 8 is a network architecture and dataflow diagram of dispatcher-initiated inbound and outbound router routines;

FIGS. 9A-9C are dataflow diagrams as a function of time, illustrating the electronic order pending processes;

FIG. 10 is an architecture diagram for a system of managing and processing pended transactions according to an embodiment of the present invention;

FIG. 10b is an architecture diagram for a system of managing and processing pended transactions according to an alternate embodiment of the present invention;

FIG. 11 is a process flow diagram of the management of an existing pended transaction according to an embodiment of the present invention;

FIG. 12 is a relational database diagram of various key identifier tables suitable for use in implementing a system according to the present invention; and

FIG. 13 is a process flow diagram depicting a linking and web domain transfer between the purchaser system, vendor system and the order pending system.

### DETAILED DESCRIPTION OF THE PREFERRED EMBODIMENTS

The present invention provides methods and systems for electronically creating and managing pended orders or transactions, thus enabling end users to create and confirm orders that can be specifically initiated for the purpose of fulfillment at a future date as prescribed by the end user, or generally “purchaser.” The purchaser can provide a specific set of fulfillment instructions for the specific purpose of having those instructions managed and executed at some future date without the end user having to reengage engage in the transaction for that transaction to be completed by that specified future date.

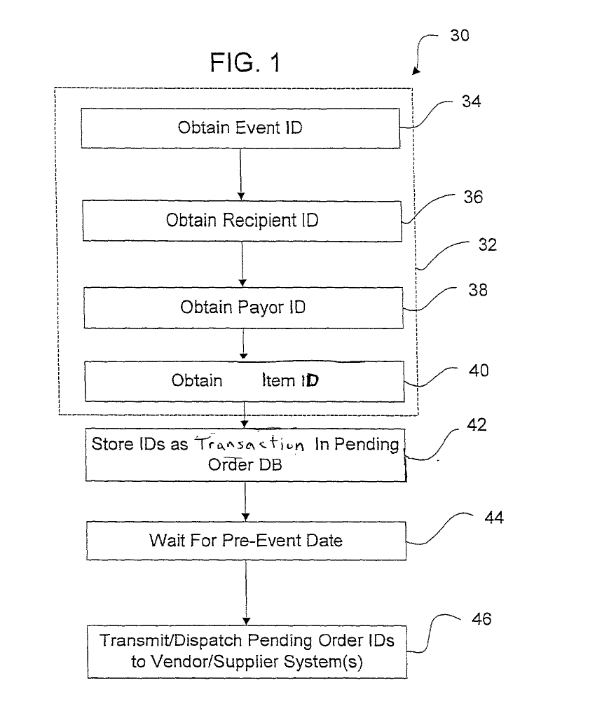

FIG. 1 is a process flow diagram chart of a method according to the present invention, showing a process or method 30 for creating a pended transaction profile that can be used as the data source for orders that will be placed with affiliated e-vendors at some point in time after the original transaction has been created. The method may be used to obtain transaction identifier datapoints, store the data as a transaction to be pended in an electronic order pending database, await retrieval based on instructions from the scheduler system, instruct the dispatcher systems to retrieve transaction profile data elements to create communications or actions that will be sent out by outbound routers or accept responses via inbound routers, and retrieve the transaction profile so that the outbound router can place the final item order(s) with the appropriate parent vendors.

With regard to FIG. 1, a transaction profiling step 32 may be seen to include several sub-steps within. An event profiling step 34 may be used to obtain information about the future event or occasion, which defines the scheduled future delivery date and the date that the electronic order pending system will place the order with the affiliated parent e-vendor. In one embodiment, the event or occasion may be a non-repeating occurrence such as a wedding, or an annually re-occurring event such as Valentine's Day, or a specifically scheduled re-occuring event such as monthly re-stocking of printer paper. Events may be identified by date and or by name.

In some methods, the event profile data elements are obtained directly from the recipient or the purchaser, for example, by keying into the order pending application. In some situations, a third-party database, such as a PDA database or electronic address book can be the electronic source of the event information. A recipient profiling step 36 may be executed to obtain information about the intended item recipient. The recipient profile information can include name, address(es), phone, age, gender, gift preferences, and/or catalogs of special dates associated with that particular recipient, or other information. In a business-to-business environment, the recipient identifier information can include company name, contact name, SIC code, product/service categories or other information. The recipient profiling data points obtained in step 36 may be obtained directly from the recipient or the purchaser by keying into the order pending application. In some situations, a third-party database such as a PDA database or electronic address book can be the electronic source of the event information. In conjunction with the interface to a third-party database, e.g., a PDA or PC calendar or scheduler such as Microsoft® Outlook®, information from the order pending database may execute certain events within the third-party scheduler. For example, a purchaser or potential purchaser may be presented with an array of events entered in their scheduler for which they may wish to pend an order with the order pending database. Based on this body of events, periodic reminders of events for which no order is pended may be presented to the purchaser to suggest pending an order, or even suggesting suitable items pertinent to widely-recognized events such as holidays, perhaps with regard to certain individuals from the purchaser's personal individual contacts database. Alternatively, existing pending orders may be shown, e.g., with an icon or thumbnail picture of a selected item, in conjunction with upcoming events in the personal scheduler of the purchaser. This may be linked to suggestive selling or upgrading solicitations or inducements, e.g., special offers or coupons.

A purchaser profiling step 38 may be used to obtain information about the purchaser of the items and creator of the pended transaction. The purchaser profile information may include the purchaser's name, address(s), phone, preferences and default payment or credit card information, or other information. Examples of payor or payment identifier infonnation can include credit card numbers, checking account numbers, intermediary electronic payment indicators, electronic cash, credit terms or equivalent information. The purchaser profiling information obtained in this way may be used immediately to pay for the item or items at the time that the transaction is initiated and prior to pending the order, or the purchaser may be debited at a time in the future, closer to the transactions fulfillment date. In some instances, certain data points such as shopping profiles and preferences may be input directly by the purchaser. In other situations, purchaser profile data points may be obtained electronically from affiliated e-vendor databases.

An item profiling step 40 can be one in which items are selected from existing affiliated e-vendor catalogs or a pre-existing “Personalized Browse Cart.” Examples of item identifiers can include parent vendor name, item name, UPC codes, DPCI numbers, parent vendor catalog number, sizes, colors, preferred vendor sources, model numbers, Internet links and any other information made available by the parent vendor to help identify and isolate the item as a unique entity among other similar items. The item identifier, obtained in step 40, may be obtained electronically by the purchaser selecting that item from an electronic catalog owned by affiliated e-vendors.

After obtaining all data elements needed to comprise the transaction profile, the transaction identifier information may be stored in the electronic order pending database step 42, to be retrieved for use in specific routines at multiple points in the future. Once accepted in the order pending database, in step 44 the transaction profile awaits instructions from the order pending system scheduler. The scheduler accesses the transaction profile in step 46 to dispatch information for communications with the purchaser and for verification and confirmation routines with the parent vendors for items included in the transaction. In most embodiments the final order placement date with the parent e-vendor is scheduled, along with all other routines required to manage and monitor the transaction during the pending period.

It may be noted that the steps illustrated in FIG. 1 may, optimally, be executed totally outside of the affiliated e-vendor's computer system or within the same internal computer system that hosts the affiliated e-vendor's business as usual procurement and fulfillment systems.

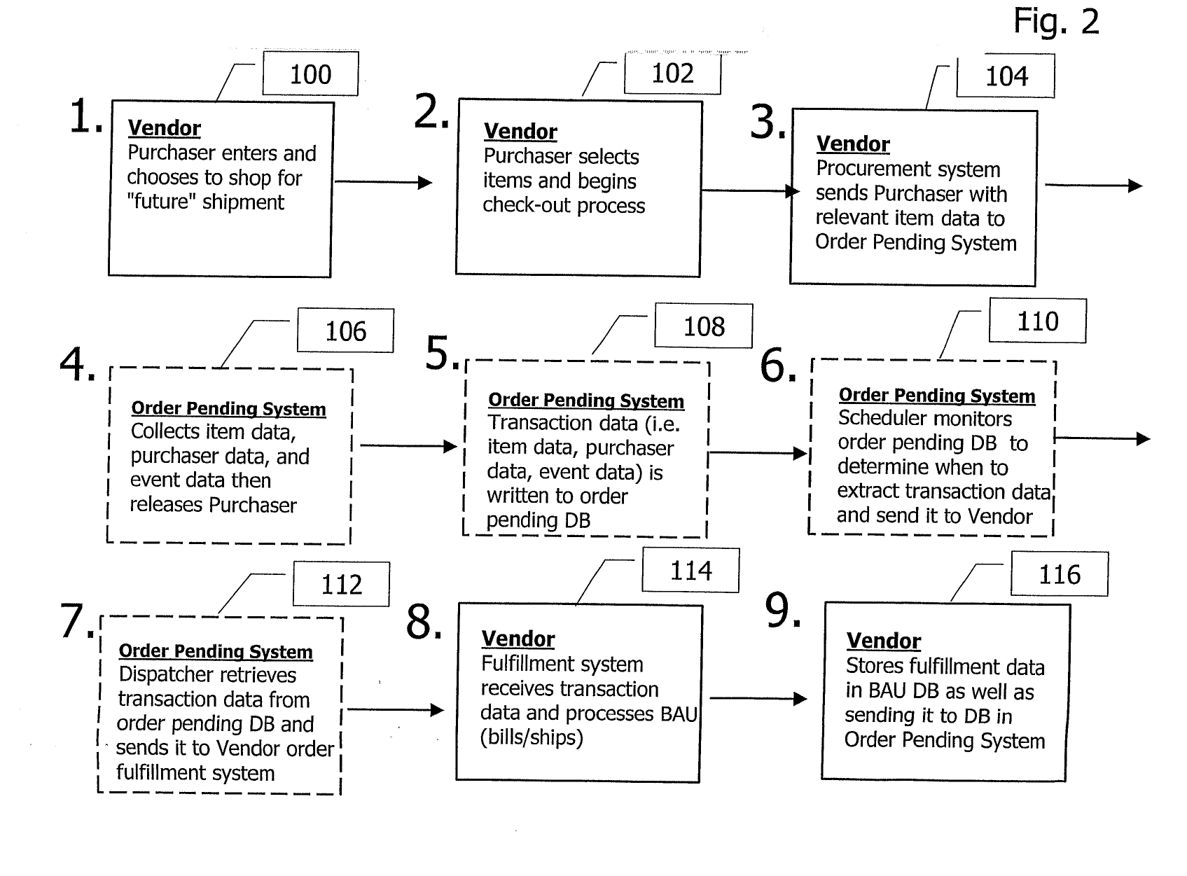

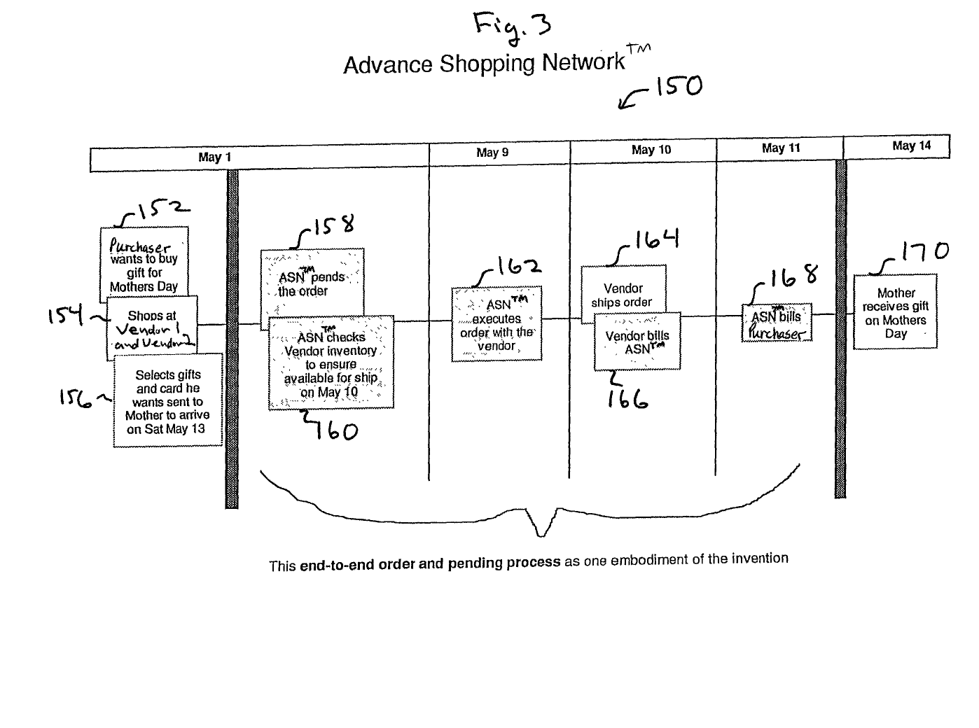

FIG. 2 is a process flow diagram of a process according to the present invention. FIG. 2 illustrates a method for a purchaser to select items for future shipment and the intervening steps between that selection and the ultimate future fulfillment, by allowing a purchaser to shop for an item or items for future fulfillment.

In step 100, while browsing the site of an affiliated electronic vendor or procurement system, a purchaser enters and selects an option to purchase for future shipment. In step 102, the purchaser selects items and begins a checkout process. In step 104, the electronic vendor's system sends the purchaser, along with the relevant item and purchaser profile data, to the order pending system. In some methods, this may be done invisibly or transparently to the purchaser. In step 106, the order pending system collects the required transaction profile data including event profile, item profile, recipient profile, purchaser profile, and then releases the purchaser. In some embodiments, this order pending system is located at a different Internet site hosted on a different physical server in a different physical location than the affiliated electronic vendor. It may be noted that, in step 106 of FIG. 2, the purchaser has been transferred from the parent vendor site to a transaction entry site, upon determination that the purchaser has the intention and/or desire of future fulfillment for a present item selection.

In step 108, the complete transaction identifier profile is stored in the electronic order pending database. In step 110, a scheduler functionality monitors the time sensitive data elements in the transaction's profile, to determine when pre-defined actions need to be taken on behalf of executing that transaction at some future date. In step 112, the order pending system, having determined that an order is to be placed, uses a dispatcher to accept data points from inbound routers and deliver data points to outbound routers to facilitate communications between the order pending system, the purchaser, or the parent vendor' systems. Ultimately, the dispatcher sends information to the outbound router to place the transaction's item orders with the appropriate parent vendors, at step 114. The electronic vendor, at step 114, receives, verifies, confirms, and processes the order, shipping the item or items to the recipient and billing the purchaser or billing the order pending system's application service provider in a batch mode for all items shipped on a particular date. In some methods, in step 116, the electronic supplier system further sends information to the order pending database system to inform the order pending database system that the order has been shipped. In some methods, the order pending system is billed for the shipped item or items, the order pending system having been previously paid for the item or items, or intending to be paid in the future for the item or items.

FIG. 3 is a timeline process demonstrating the execution of an embodiment of the present invention. FIG. 3 illustrates an example timeline 150 of one embodiment of the electronic order pending process in a scenario related to a purchaser buying an item for a specific special occasion, the end-to-end pending cycle for a sample transaction tied to the specific event of Mother's Day. As used herein, the term “Electronic Order Pending Network,” the service mark “Advance Shopping Network” or “ASN,” and the service mark “Pend Pro” are used interchangeably. In the example, in step 152, a customer wishes to buy an item for Mother's Day several week prior to the occurrence of Mother's Day. The customer shops at Vendor 1 and Vendor 2 at step 154. While at the vendor' sites, the purchaser selects items for delivery to his Mother on Mother's Day at step 156. The purchaser's awareness of the involvement of the order pending site may or may not be transparent or even unknown to that purchaser. In step 158, the order pending system pends the transaction for later transmission as an order to the parent e-vendors A and B. In some methods, at step 160, the order pending system checks the vendor's inventory to ensure accuracy and availability of items for shipment on a certain date. In a preferred embodiment of the subject invention, the administrator of the order pending database may implement a system to aid in logistics assurance, for example, in partnership with a third-party e-vendor. For example, the order pending database owner may implement a system by which, in conjunction with product availability confirmation messages as described herein, the order pending database owner can provide for notification of product upgrades or new models or versions, to a purchaser during the period in which a transaction is pending. The purchaser may be presented with a message informing them of a possible product upgrade they may wish to take advantage of, with an option to effect the upgrade. Similarly, the purchaser may be notified of situations in which the pended order item may not be available. The purchaser may be presented with options for alternate products they may wish to substitute. A vendor may wish to offer a discount in connection with this alternate or “second choice” suggestion. Alternately, a vendor may, in the case of product unavailability, have the order filled by a third party or alternate supplier, in a manner that is transparent to the purchaser and recipient, in order to maintain customer loyalty. The vendor may, for example, notify the order pending database administrator of the product unavailability, and either present an alternate or substitute product, or request help in having the order filled through another fulfillment entity, preferably transparently.

At the parent vendor's fulfillment date, which can be defined by the parent vendor as a specific number of days prior to the event date, the order pending system executes an order with the e-vendor at step 162. The order having been transmitted to the parent e-vendor, it is fulfilled and shipped at step 164. The parent vendor can bill the order pending system at step 166. In some methods, the customer is billed directly by the parent vendor. In the embodiment illustrated, at step 168, the order pending system bills the purchaser. At step 170, the recipient receives the items no later than the requested delivery date, which in this case is the occasion date, e.g. Mother's Day.

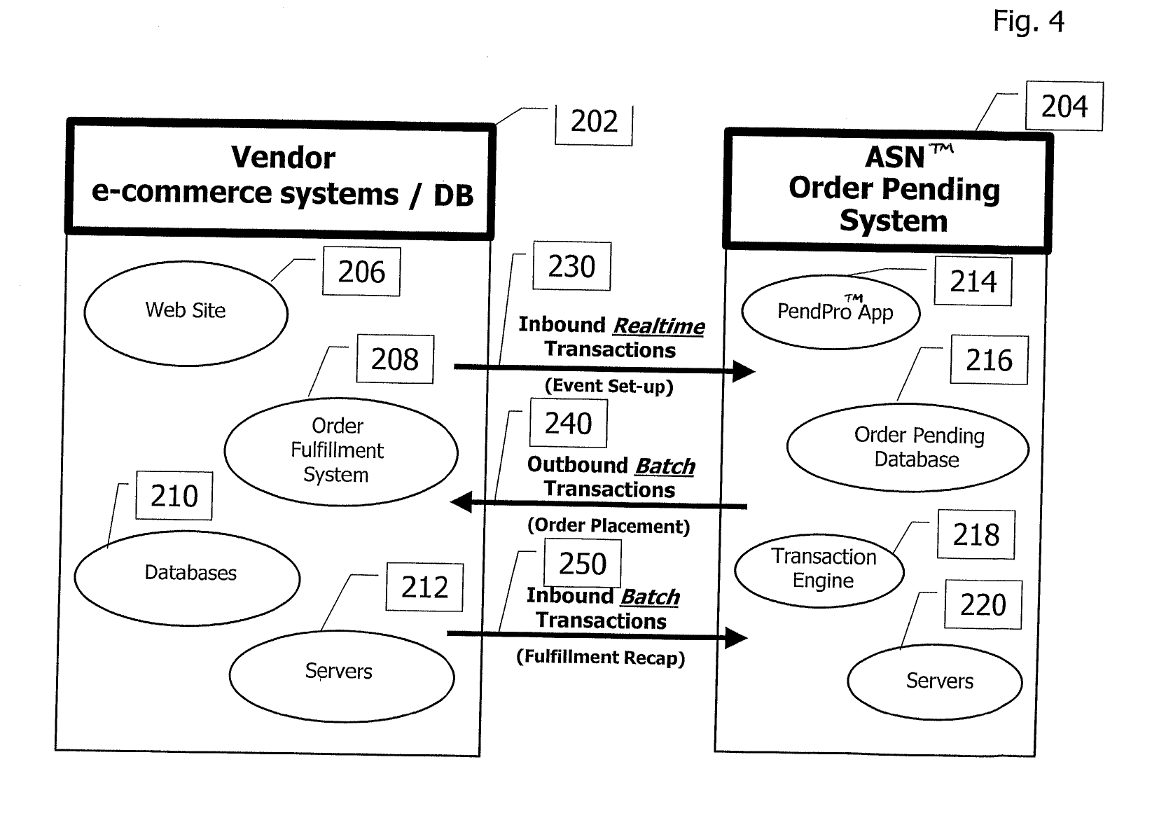

FIG. 4 is a dataflow diagram of the batch and real-time (synchronous and asynchronous) flow of data points between the system environments of the system entities. FIG. 4 illustrates a high level diagram of a data flow and/or transaction flow between an e-commerce system 202 and an electronic order pending system 204. As seen in FIG. 4, the electronic commerce system 202 can include an e-vendor's website 206, an order fulfillment system 208, database 210, and servers 212. The electronic order pending system 204 may be seen to include an executable order pending software application 214, the order pending database 216, a transaction engine 218, and servers 220. In-bound, real-time transactions may be seen to flow from e-commerce system 202 to order pending system 204 at 230. In-bound, real-time transactions can include the transmission of transaction identifier information, for example, the event identifier, the recipient identifier, the item identifier, and the purchaser identifier. The order pending system 204 may be seen to transmit out-bound batch transactions 240 to the e-commerce system 202. The out-bound batch transactions can include the dispatch or placement of the order with the vendor. After receipt of the out-bound batch transactions, e-commerce system 202 may transmit in-bound batch transactions to 250 to the order pending system 204.

The e-commerce system 202 can include the retail website 206, requiring little explanation. The order fulfillment system 208 can include all aspects of order fulfillment systems commonly found in on-line or electronic vendors, suppliers or retailers. Databases 210 can be used to both store the inventory and financial data of a common electronic vendor, as well as to record the transaction identifiers, in some embodiments. Servers 212 may be used to communicate with website browsers as well as order pending systems.

Order pending system 204 may include the executable application 214 which may be used to obtain the transaction identifier information. The transaction identifier information may be stored in order pending database 216, and later queried by transaction engine 218 which can include a scheduler function. Servers 220 may be used to handle requests from in-bound, real-time transactions 230, in-bound transactions 250, as well as internal requests from the order pending application 214 and the transaction engine 218. In some embodiments, in-bound batch transactions 250 may include requests for payment from e-commerce system 202 to order pending system 204. In an embodiment of the invention, payment may be effected according to a sequence of alternate payment sources, e.g., a number of credit cards. If a credit card, for example, reaches a credit limit after which no credit is granted by the creditor, naturally the pended order will fail for lack of funds. The administrator of the order pending database may implement an automatic substitution of a back-up credit card, according to prior agreement with the purchaser. The administrator of the order pending database may even wish to grant credit itself to certain purchasers, providing a back-up itself to possible payment failures.

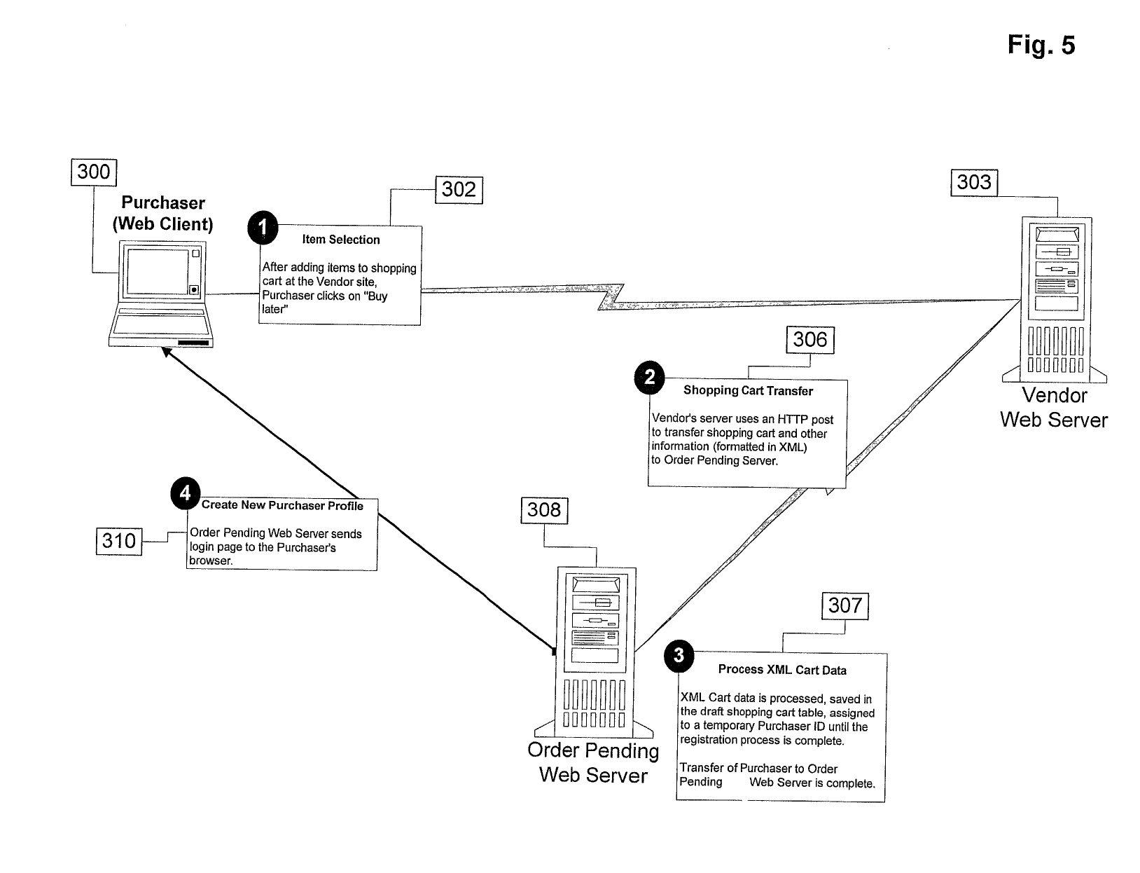

FIG. 5 is a network architecture and dataflow diagram of a system for obtaining transaction identifier information from a purchaser who wishes to use the order pending system. FIG. 5 illustrates the links between the order pending system, the electronic vendor web server, and the web client. The dataflows depict the interaction of affiliated e-vendor' possible business-as-usual procurement or fulfillment system elements and the electronic order pending system elements.

A web client 300 may be used by a purchaser who adds items to a shopping cart at the parent vendor's website, later selecting in some manner, such as by clicking on, “buy later” at 302. Control may transfer to an order pending system web server 308 at this point. At 306, the e-vendor's web server 303 can use any appropriate method, for example, an HTTP post, to transfer shopping cart and/or other information, for example, formatted in XML, to the order pending system. Transferred with control to the order pending web server 308, the transferred shopping cart data is processed at step 307, and may be assigned a temporary purchaser identifier until the transaction profile process is complete. At this point, in some methods, transfer of the purchaser to the order pending system is complete. At step 310, the order pending system web server 308 can send a login page to the purchaser's screen, thereby transferring the purchaser back to his original starting point web client 300.

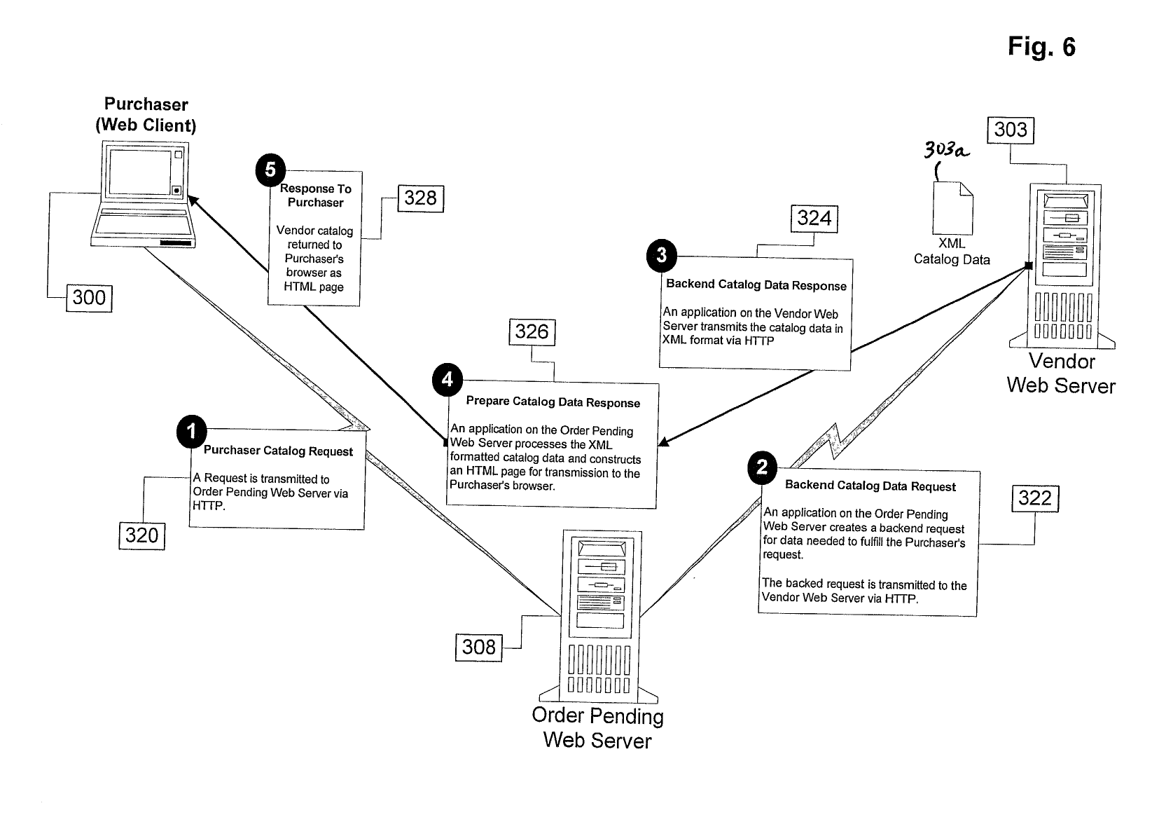

FIG. 6 is a network architecture and dataflow diagram showing communication between the electronic order pending system and an affiliated electronic vendor's web-based catalog. FIG. 6 illustrates communication between the order pending system and the vendor's electronic catalog. Proceeding from the last step referred to in the previous figure, a purchaser's catalog request 320 is transmitted to the order pending web server 308 via an appropriate protocol, for example, HTTP. After the purchaser's item request is transmitted, an application on the order pending web server 308 can create a back end request for data needed to fulfill the purchaser's request at step 322. The backend request may be transmitted to the e-vendor web server 303 via an appropriate protocol, for example, HTTP. After the backend catalog data request is sent, an application on the e-vendor web server 303 can transmit the catalog data in an appropriate format, such as an XML format document 303a, via an appropriate protocol such as HTTP at step 324. After the backend catalog data response, an application on the order pending web server 308 can process the XML formatted catalog data and construct an HTML page for transmission to the purchaser's screen at step 326. The vendor catalog can be returned to the purchaser's screen as an HTML page at step 328.

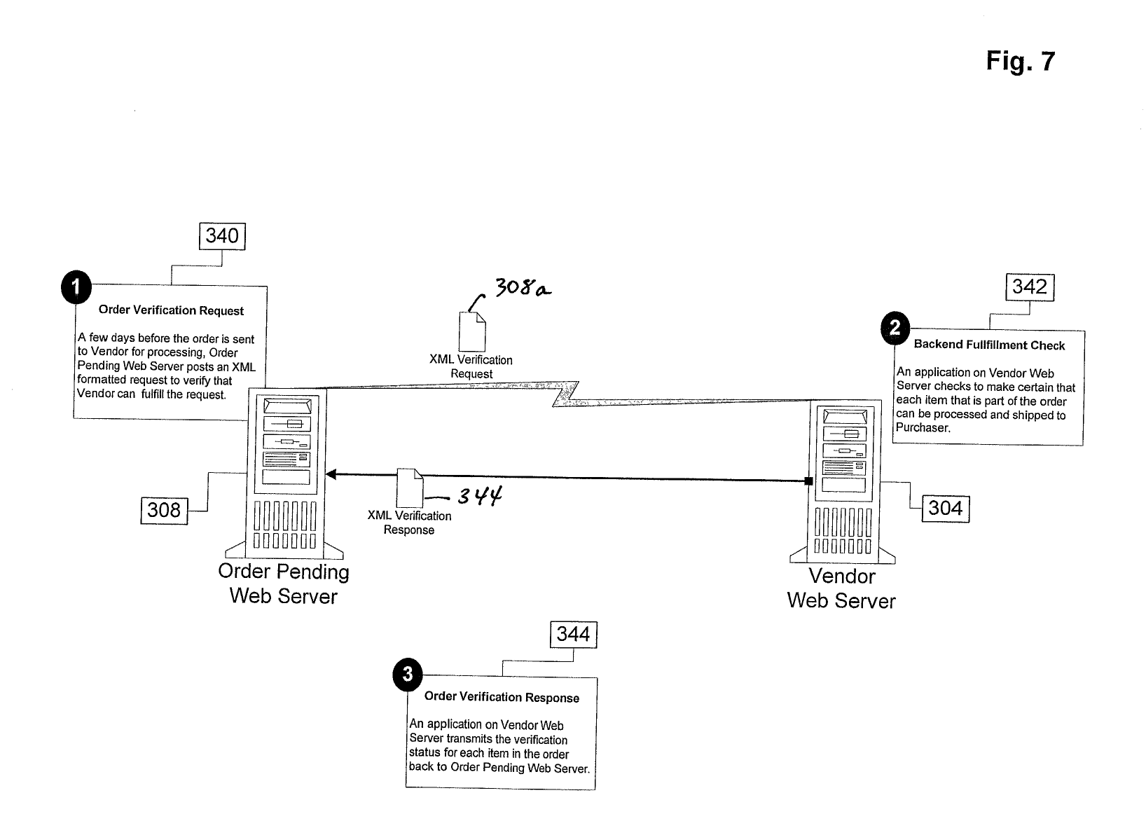

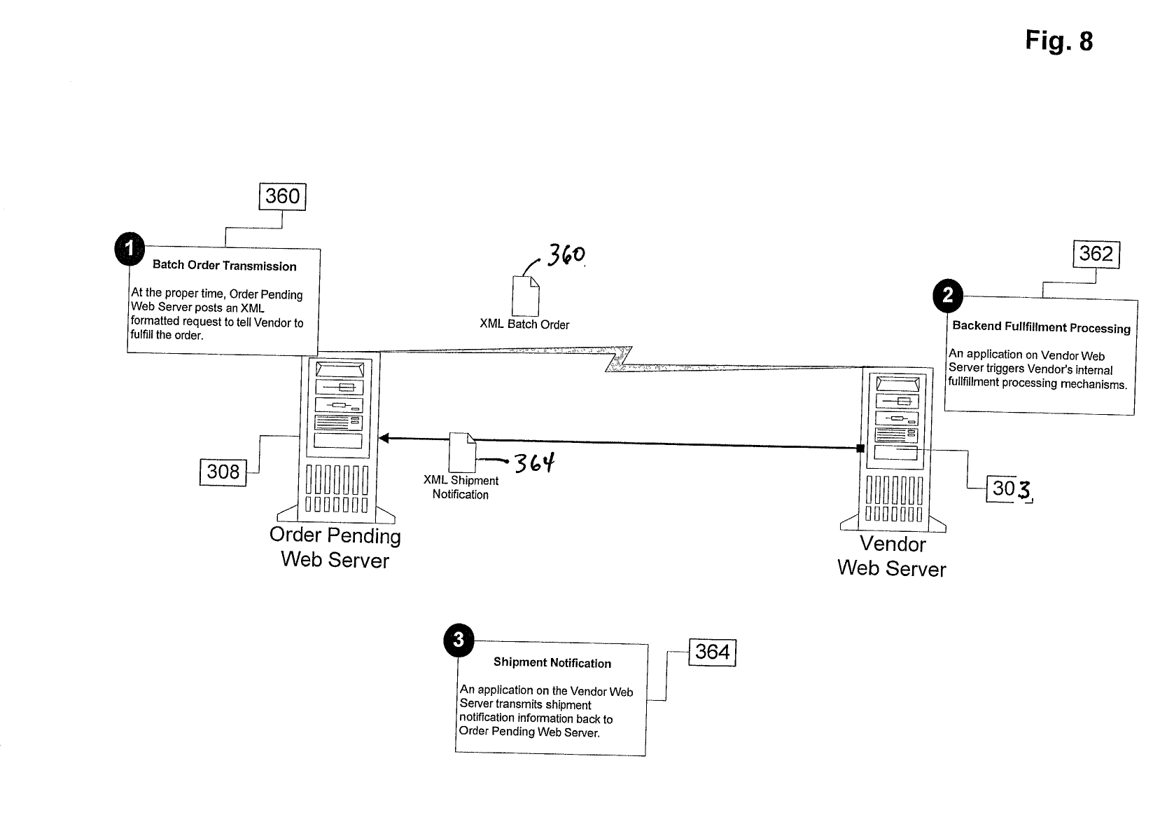

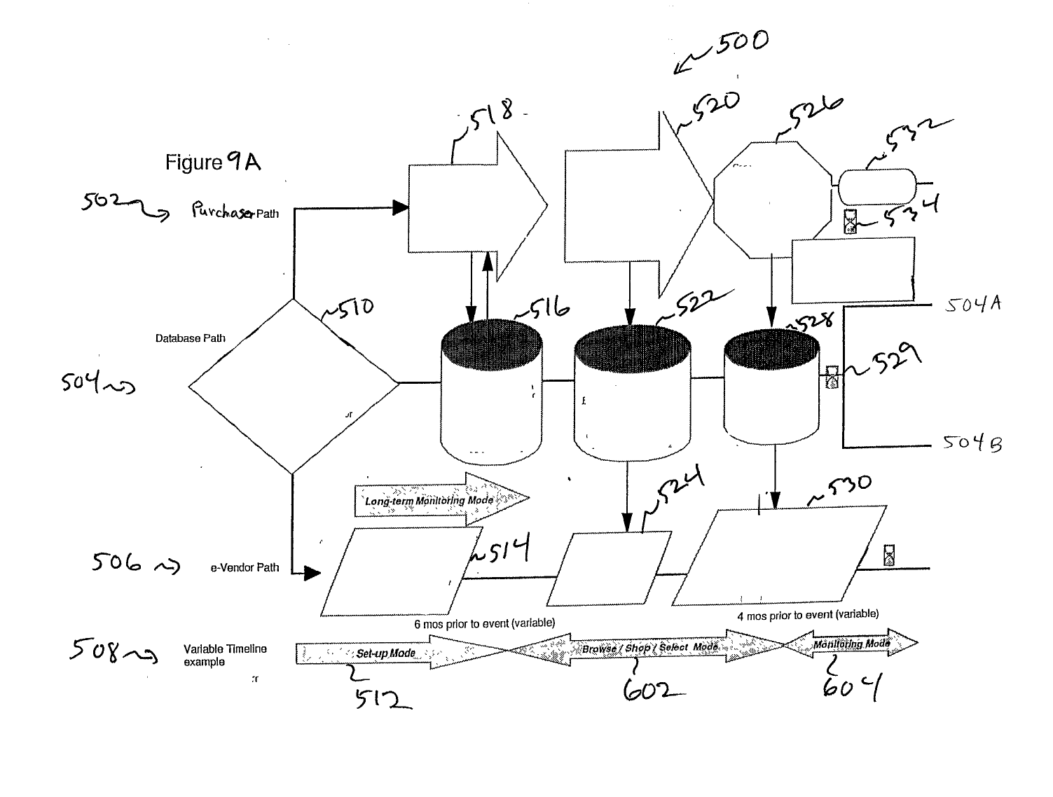

FIG. 7 is a network architecture and dataflow diagram of the dispatcher and inbound/outbound router communications to transmit and exchange order verification data. FIG. 7 illustrates further communication between order pending web server 308 and a e-vendor's web server 303. As previously described, e-vendor's web server 303 and order pending web server 308 may reside in the same or different computers, or the same or different computer cluster, which can vary depending on the embodiment implemented. After the last described communication in the previous figure, the order pending web server 308 can post an XML or other formatted request 308a to verify that the e-vendor can fulfill the request at step 340. This order verification request may be made a few days before the order is sent to the parent vendor for processing, or at one or more other times. After reception of the order verification request, a backend fulfillment check 342 may be executed on e-vendor web server 303. In the backend fulfillment check, an application on the e-vendor's web server may check to make certain that each item that is part of the order can be processed and shipped to the recipient. After the backend fulfillment check, an order verification response 344 may be transmitted from e-vendor's web server 303 to order pending server 308. The order verification response 344 can transmit the verification status for each item in the transaction back to the order pending server 308.

FIG. 8 is a network architecture and dataflow diagram of dispatcher-initiated inbound and outbound router routines. FIG. 8 illustrates procurement and order fulfillment communication between order pending server 308 and e-vendor's web server 303. The data flows depicted in FIG. 8 are those used to facilitate the exchange of information needed to place an order from the electronic order pending system into the procurement system of an affiliated e-vendor. After completion of the last described communication on the previous figure, a batch order transmission 360 may be executed. This batch order transmission may include more than one item request. At the proper time, the order pending web server 308 can post an XML or other formatted request to inform the supplier to fulfill the order, at step 360. After reception of the batch order transmission, a backend fulfillment processing step 362 may be executed on the evendor's web server 303. In the backend fulfillment processing step 362, an application on the e-vendor's web server 303 can trigger the e-vendor's internal fulfillment processing mechanism. After the backend fulfillment processing step 362 has been executed, a shipment notification step 364 may be executed by an application on e-vendor web server 303. The shipment notification step 364 can transmit shipment notification information to the order pending server 308.

The e-vendor server 303 is illustrated in FIGS. 5 through 8. In some embodiments of the invention, the vendor discussed with respect to e-vendor server 303 in FIGS. 5 and 6 may be a different entity than the vendor discussed with respect to e-vendor server 303 in FIGS. 7 and 8. In one example of the invention, the vendor discussed with respect to FIGS. 7 and 8 is a supplier that fulfills the order, but may not host the catalog or even be related to the vendor involved with the order taking process. In one example, the vendor discussed with respect to FIGS. 7 and 8 is a warehouse or fulfillment center that accepts orders from the vendor discussed with respect to FIGS. 5 and 6 which hosts a catalog and accepts retail orders. In some embodiments, the vendor business entities of FIGS. 5 through 8 are the same entities, or are closely related entities.

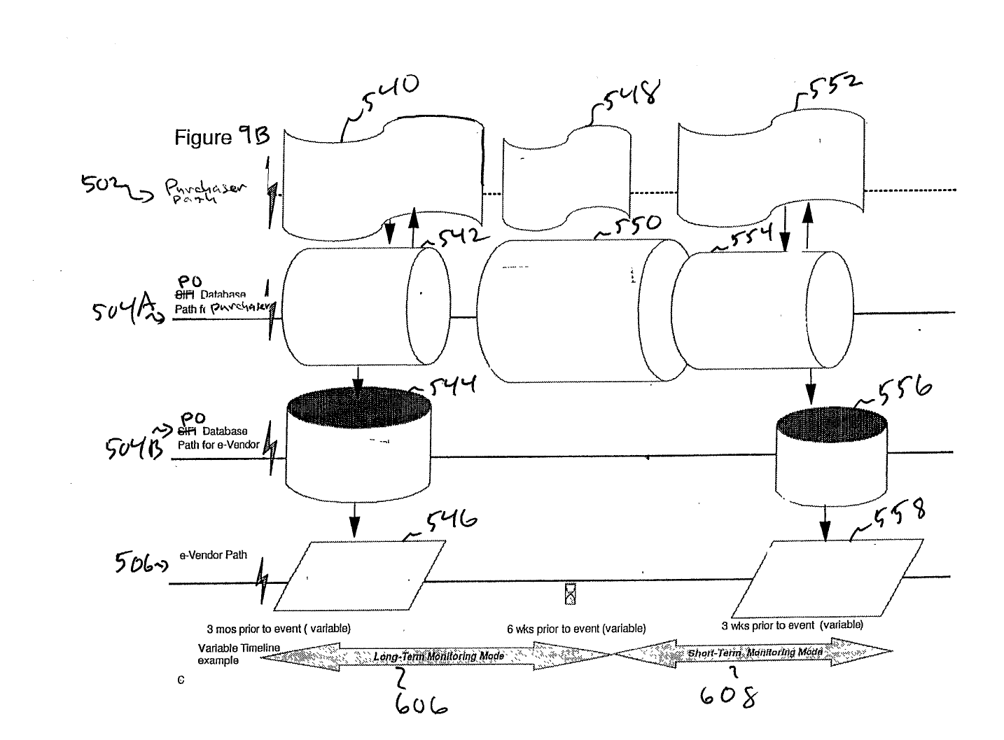

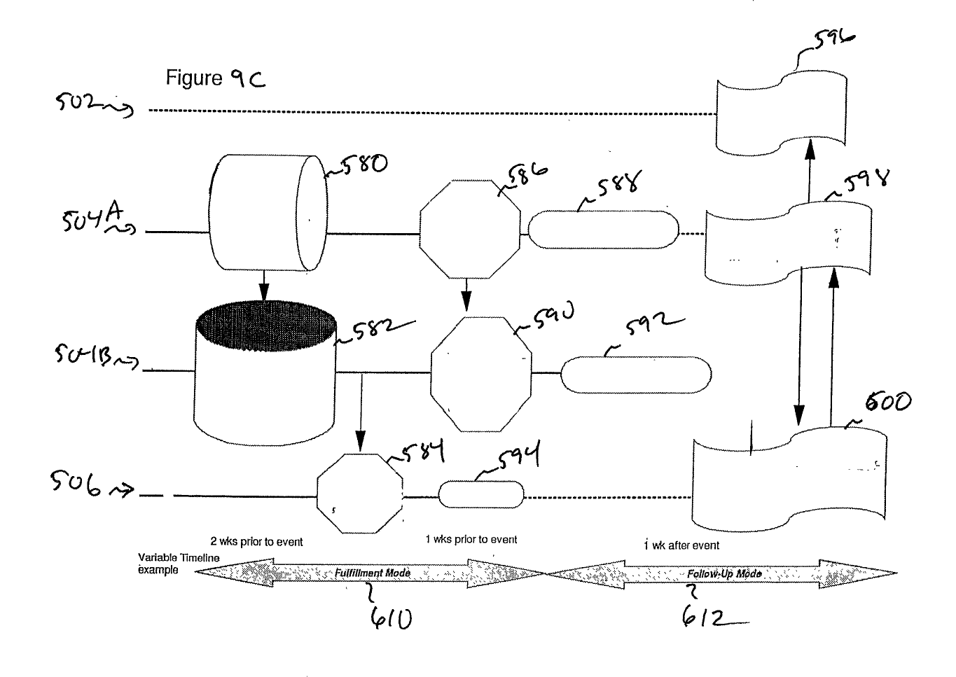

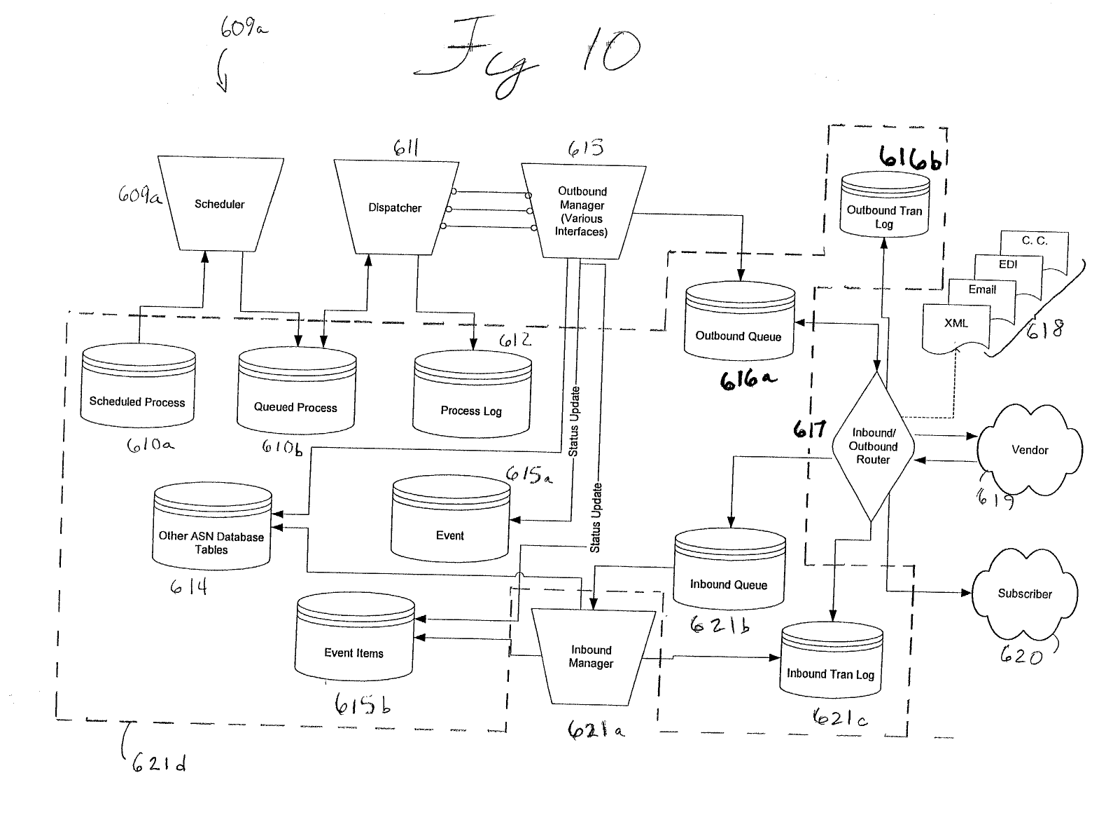

FIGS. 9A-9C are dataflow diagrams as a function of time, illustrating the electronic order pending processes. FIGS. 9A through 9C illustrate a timeline of event driven selecting, ordering, purchasing, and fulfillment for future events. A timeline 500 may be seen to extend from FIG. 9A through 9C. Timeline 500 includes generally a purchaser or consumer path 502, a database path 504, an electronic vendor path 506, and a variable timeline 508. Various nodes and data paths are illustrated generally in FIGS. 9A through 9C.

Variable timeline 508 may be seen to extend generally from a set up mode 512, to a browse/select mode 602, to a monitoring mode 604, to a long term monitoring mode 606, to a short term monitoring mode 608, to a fulfillment mode 610, ultimately proceeding to a follow-up mode 612. The fulfillment may also be effected according to a logistics assurance procedure as requested by the vendor or fulfillment entity. For example, a vendor may have a standing request in place for automatic logistics assurance procedures in the event of product unavailability.

In database path 504, node 510 illustrates that the order pending database is used as an application source and engine for order pending network information structure applications to be accessed electronically. The database can be accessed electronically by purchasers and affiliated e-vendors. During set up mode 512 indicated in variable timeline 508, a software vendor can install a set of linking instructions referred to as “Revolving Door Links” (RDLs) interface layer on top of the existing procurement system to allow the order e-vendor's e-catalog information to flow to and from the order pending database, as indicated at 514. In the database path at node 516, the order pending database can create a universal registration for the purchaser, typically the person initiating the purchase, and can accept inputs and data points about events that the purchaser wants the system to manage. In the purchaser path at 518, the order pending network purchaser can subscribe, register, and begin to compile required transaction identifier data points for the transaction that the purchaser would like to have executed at least three weeks before the event date. Transactions are executed at various times, such as for example, at least 1, 2, 3, or 4 weeks, etc., before the event date, in alternative embodiments of the invention.

During browse/select mode 602, as indicated in the purchaser path at 520, the order pending network purchaser can use a specific event from the order pending database to initiate an RDL to enter the affiliated vendor's domain to select items for the specific future event or delivery date. As indicated in the database path at 522, the order pending database can pass universal registration information to the RDL interface layers so that the vendor knows that an order pending network purchaser has visited their domain even before any selection is made. In the electronic vendor path at 524, the order pending system allows the purchaser to enter the appropriate affiliated e-vendor's domain to make item selections. In the purchaser path at 526, the purchaser may select items for the event from one or more affiliated vendors so that these items are made part of an order pending cart for that transaction and event. The RDL allows easy one step access to other affiliated e-vendors as is acceptable by the e-vendor who is the parent owner of the original selection activity. In the database path at 528, the database accepts selections for that event and a monitoring mode can be initiated. In a preferred embodiment, no billing occurs at this time. In the electronic vendor path at 530, the electronic vendor can accept the item selection identifier and the associated universal registration information and can do an electronic hold of the items with the vendor to ensure they are available for shipping on a specified date. As indicated by the hourglass symbol at 534 near the purchaser path at 532, no further action is required by the purchaser and he can remain passive or inactive throughout the rest of the pending and execution process.

FIG. 9B shows the next portion of the timeline, long term monitoring mode 606, including purchaser path 502, electronic vendor path 506, with the database path being bifurcated at 529 into an order pending database path for purchasers 504A and an order pending database path for electronic vendors 504B. In the purchaser path at 540, the purchaser may optionally input instructions about shipping, consolidating item requests, special handling, or other changes at any time during the monitoring mode. The order pending shopping cart may also be cancelled or modified anytime during the monitoring mode. As indicated in the order pending database path at 542, the order pending database holds the information for the order pending shopping cart for that event. The data in the order pending database is fluid or variable at this point and may be changed by the purchaser. As indicated in the order pending database path for electronic vendor at 544, selection in the order pending shopping cart can be processed and updated in batch mode, for example, at night, for access by the electronic vendor(s) who had transactions complete during the prior day. As indicated in the electronic vendor path at 546, the vendor can use the time between the electronic hold and the ultimate order execution to plan inventory and interact with the purchaser for suggestive sellings, i.e., up-selling and or cross-selling. Other suggestive selling opportunities may be afforded in conjunction with the logistics assurance modality discussed earlier. For example, in the event of product unavailability, an alternate or suitable substitute product may be presented to the purchaser, or in suitable cases, the recipient. For example, this opportunity may arise with regard to new model replacement of an outdated model of an item.

As indicated in the purchaser path at 548, the purchaser may optionally repeat the item selection process immediately or at some time in the future for any other events that have been stored in the order pending database. As indicated in the order pending database path at 550, at a calculated time prior to the event, the order pending database is queried by the scheduler, and the transaction identification information extracted and used to initiate the process or processes of executing the orders with the electronic vendor. In one embodiment, the order pending scheduler dispatches an order to the parent vendor one to two weeks prior to the requested fulfillment date for the transaction. In other embodiments, the order pending scheduler dispatches an order to the parent vender, e.g., at least 3 or 4 weeks prior to the requested fulfillment date for the transaction. No involvement or action from the purchaser is required at this point. As also indicated in the order pending database path at 554, the order pending database can send the purchaser a notice that the event is about to happen and that the transaction as placed earlier will now be executed and completed. Again, no action is required on the part of the purchaser, unless the purchaser wishes to change any of the instructions previously given.

As indicated in the purchaser path at 552, the purchaser may optionally input instructions about shipping, consolidation of items, or special handling, immediately or at any time during the monitoring mode. The purchaser action at 552 may be in response to the order pending database actions initiated at 554. As indicated in the order pending database for the electronic vendor at 556, the order pending database dispatcher can place an order with the parent vendors who have items in the pended transaction for the event being processed. As indicated in the electronic vendor path at 558, the vendor can do a batch order fulfillment for all order pending system orders for that day and create one billing to the order pending network for all items regardless of how many purchasers are attached to the orders. In one embodiment, this is executed about three weeks prior to the event.

FIG. 9C illustrates the third portion of time line 500, in fulfillment mode 610. In the order pending database path for the purchaser at 580, the order pending database can charge the purchaser's credit card or create an invoice for the entire transaction for that event, regardless of how many different vendors have items included for that event. In the order pending database path for the electronic vendor at 582, the order pending database can execute a command to the vendor's RDL interface layer which can talk to the vendor's order entry system, thereby providing all the transaction information needed for the vendor to execute an order on behalf of that purchaser. In the electronic vendor path at 584, the vendor can ship the order either to the recipient or to the order pending network consolidation's center.

In the order pending database path for purchasers at 586, the order pending network purchaser service function can complete special handling requirements, if any, as instructed by the purchaser prior to items being shipped. In the order pending database path for the electronic vendor at 590, the order pending database can automatically remove an item or items from the electronic hold status in the vendor's RDL interface layer to a completed transaction status. As indicated in the order pending database path at 588, the required purchaser commands are complete. As indicated in the order pending database path for the electronic vendor at 592, the required database vendor commands are done. As indicated in the electronic vendor path at 594, the vendor requirements are complete.

During the follow-up mode 612, in the electronic vendor data path at 600, the vendor may optionally use the RDL interface layer to interact with the purchaser for follow-up, “thank you” messages, reminders to browse and select items for the same event with them again next year, and/or special offers for ordering for the same event with them for the following year. In the order pending database path for purchasers at 598, the order pending database may optionally interact with the purchaser to prompt him or her for other future events for that recipient for that same event for the same recipient in the coming year. Special offers may be made at this time. In the purchaser data path at 596, the purchaser may optionally receive follow-up interaction and information needed to repeat the process for the same event, the same recipient, and or other events and recipients.

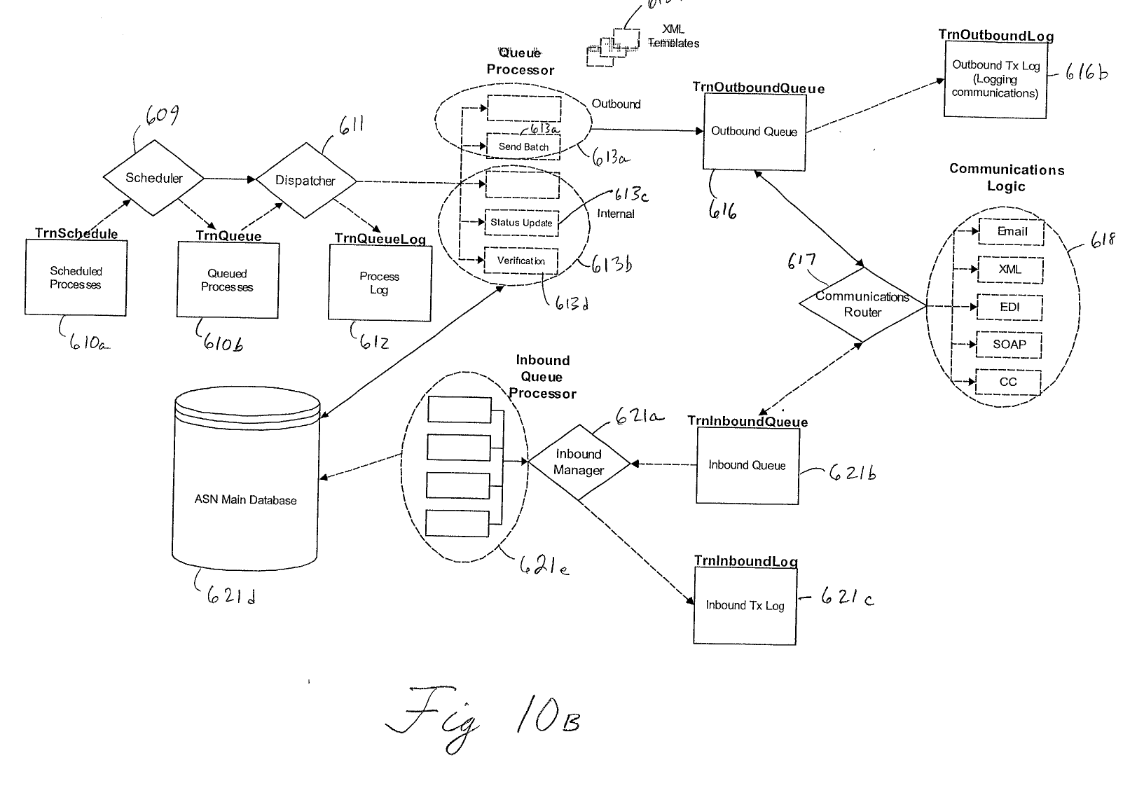

FIG. 10 is an architecture diagram for a system of managing and processing pended transactions according to an embodiment of the present invention. FIG. 10 depicts the system architecture of the scheduling process that may be implemented according to the present invention to facilitate the management and processing of pended transactions. An Order Pending System according to an embodiment of the present invention is depicted generally at 609. In this embodiment, scheduler module 609a is placed in control of the pended transaction. Scheduler module 609a checks instruction sets datastore (or data table) 610 for time-sensitive routines that need to be run against any data elements contained in the pended transaction. When instructions to be scheduled are found in instruction sets datastore 610, the scheduler module 609 directs the instructions to the dispatcher module 611. Dispatcher module 611 creates an entry in a process log datastore to support the actions that need to be taken as follows: The process log details are communicated by the dispatcher module 611 to the outbound manager module 613. Outbound manager 613 makes a determination about what additional data elements are needed to effect the pended transaction. All required data elements are extracted from the transaction tables of the order pending database 614 and linked to the appropriate event identifier in event database 615. The event identifier information is used to label the instructions that are put into an outbound queue and logged at 616 and sent to the inbound or outbound routers at 617 so that communications between the required vendor 619 or subscriber/purchaser 620 systems can be executed using any one of multiple standard communications protocol as 618 shows. The response to the instructions is accepted by the Inbound router and queued and logged at 621 so that the inbound manager can stage the response for the next appropriate action by the scheduler at 609. It may be noted that, according to a representative embodiment of the present invention, database elements Scheduled Process 610a, Queued Process 610b, Process Log 612, Remaining Database Tables 614, Event 615a and Event Items 615b, as well as Outbound Transaction Log 616b, Outbound Queue 616a, Inbound Queue 621b, and Inbound Translation Log 621c, may be generally considered as a whole Order Pending Database 621d, as indicated. Inbound manager 621a accepts incoming order pend requests and transactions, as well as submitted profile and payment information, submitted by Vendor 619 or Subscriber/Purchaser 620. The relevant data is entered in Event Items database 615b, as well as the ASN database tables 614. These incoming transactions and information are logged in Inbound Transaction Log 621c, as are Outbound Transactions to Outbound Transaction Log 616b. The transmission of communications between the order pending system and the external world is managed by Inbound/Outbound Router 617, according to Inbound Queue 621b and Outbound Queue 616a, with respective queue priority and inter-queue transmission conflicts determined by rules regarding communication priority.

FIG. 10b is an architecture diagram for a system of managing and processing pended transactions according to an alternate embodiment of the present invention. In this alternate embodiment of the present invention, the Order Pending Database 621d is represented as monolithic, the subsidiary database elements not shown. In this embodiment, Outbound Queue 616a, Inbound Queue 621b, and Inbound Transaction Log 621c are depicted and maintained as separate databases from Order Pending Database 621d. Alternatively, the order pending system according to the present invention may be implemented to include Outbound Queue 616a, Inbound Queue 621b, and Inbound Transaction Log 621c, as depicted by the relational database 621d of FIG. 10. As shown in FIG. 10b, communications with entities external to the order pending system administrator may be effected via, e.g., E-mail/SMTP, XML, EDI, SOAP, or CC, see 618. Inbound Queue Processor 621e communicates with Inbound Manager 621a so that transaction/orders in the Inbound Queue will be logged appropriately in Order Pending Database 621d. Queue Processor (613a, b) carries out a function comparable to that of Outbound Manager 613 of FIG. 10. Queue Processor 613a, b encompasses an Internal Process 613b, effecting various processes for internal processes e.g.status update 613c and verification 613d processes, as described in detail herein. Outbound Process 613b of Queue Processor (613a, b) performing, e.g, batch message transmission via process 613e, transmitting completed XML templates 613f.

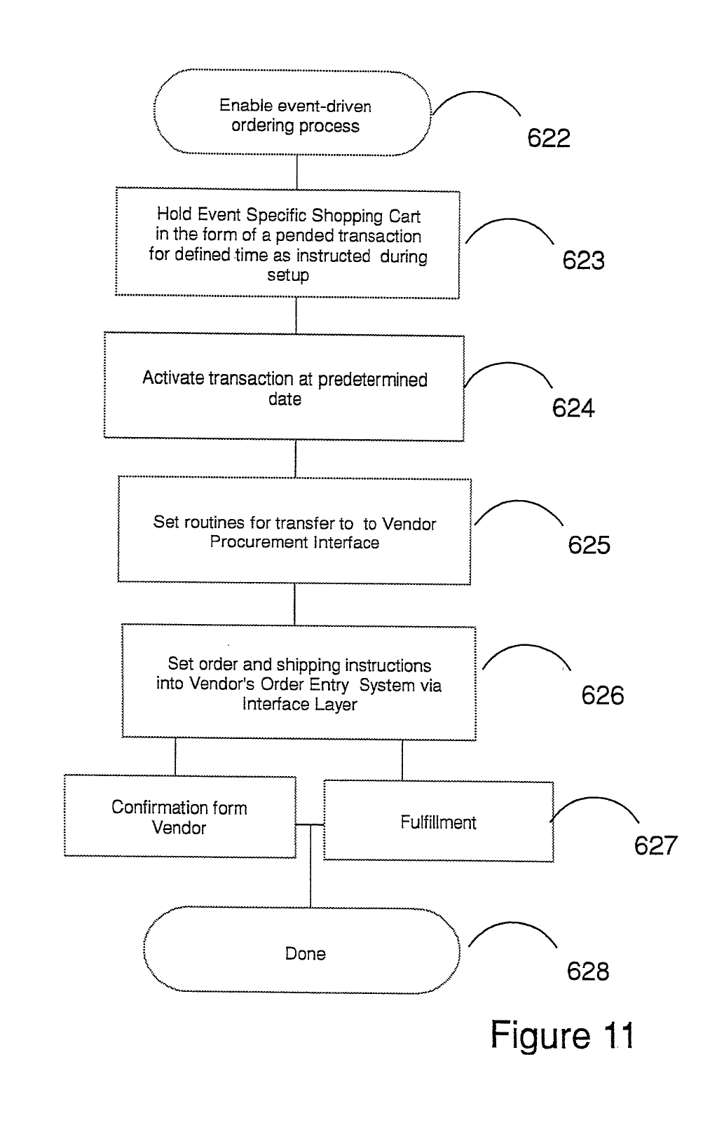

FIG. 11 is a process flow diagram of the management of an existing pended transaction according to an embodiment of the present invention. FIG. 11 depicts the management of a pended transaction once it has been created. A pended transaction has already been created at state 622. Following this, the system holds the transaction in a data element or storage structure at state 623 that is tied to a specific event that was defined by the originating purchaser. This shopping cart or transaction information is stored in the order pending database as a pended transaction. At step 624, the pended transaction is activated by the scheduler dispatching inbound instructions to the database so that at 625 the required information from the pended transaction can be used to execute scheduled routines needed to complete an order with the parent vendor's procurement system. When all preliminary routines are completed, the order is placed at 626 with the parent vendor through links that allow communication between the order pending system and the vendor' systems, e.g., EDI links. At 627 the parent vendor confirms and fulfills the order and the transaction is complete for execution at 628.

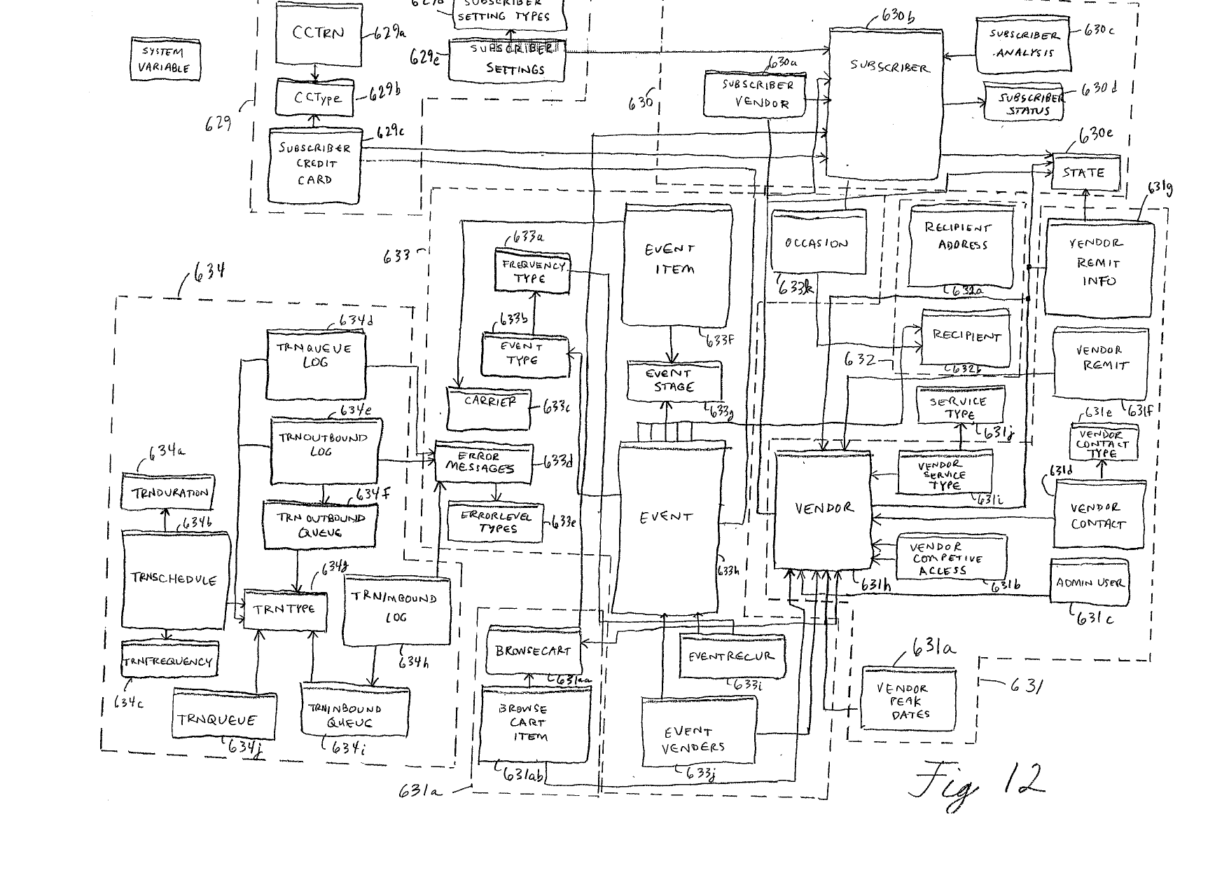

FIG. 12 is a relational database diagram of various key identifier tables suitable for use in implementing a system according to the present invention. FIG. 12 is a key identifier diagram depicting a suitable manner of how various key identifier tables implementing the present invention may be stored in and accessed from the order pending database. FIG. 12 also depicts (using arrows) the referential integrity between key tables. Specifically, these arrows show the referential integrity supplied by the primary key/foreign key relationships between tables, according to standard relational database notation. For example, a purchaser and his credit card (CC) information may be stored according to the key scheme of the tables of 629 (i.e., contained within data fields of key tables 629a, b, and c) as well as the details related to the purchaser's name, addresses(s), phone, preferences, passwords, etc. at 630 stored with data fields of key tables 630a, b, c, and d. Vendor data element tables house the data points needed to integrate vendor identifiers into a transaction as well as the information required to access the vendor' e-catalog, submit selection reports, verify and confirm orders, place orders, and communicate transaction profile info into the vendor' systems at 631. As a result of selections made from the vendor's e-catalog, the purchaser may also want to create a “Personalized Browse Cart” (see key table 631a) and those data elements may be placed in a separate set of tables as well.

As depicted in key tables FIG. 12, the key tables which may hold recipient data elements are shown within box 632; i.e., key tables 632a and 632b. The occasion and event identifiers which dictate the desired delivery date, indicated generally by 633, may be held in separate tables as shown by 633a-633j. All information from the data store that pertains to any element of key identifier tables expressed in 629 through 633 are summarized and assigned execution routine level identifiers and stored in transaction date element tables as shown at 634. It is the transaction tables that hold the data elements that are acted on to identify and execute routines necessary to manage an order from the time it is placed to the time it is filled.

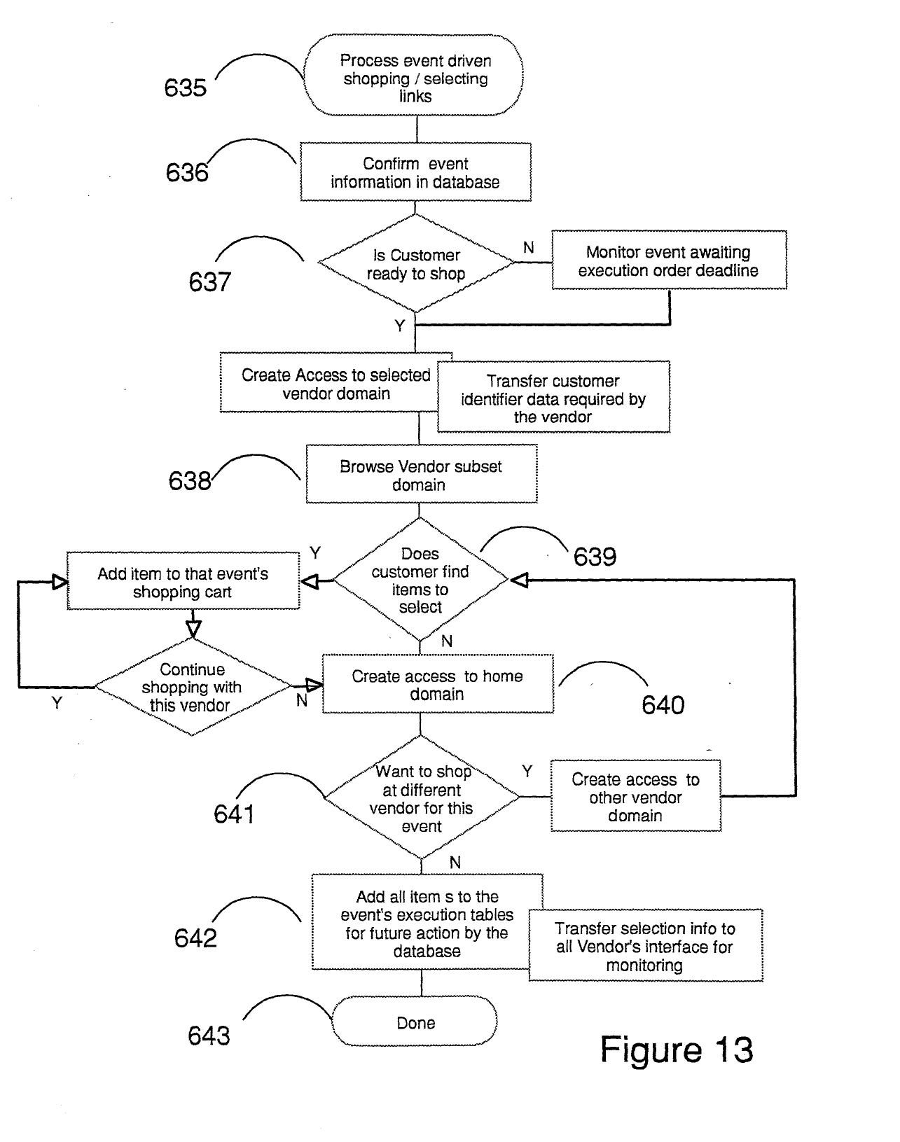

FIG. 13 is a process flow diagram depicting a process that demonstrates a linking and web domain transfer between the purchaser system, vendor system and the order pending system. FIG. 13 depicts a process flow diagram demonstrating a linking and web domain transfer between the purchaser system, vendor system and the order pending system. Assuming that a purchaser at 635 has initiated a transaction to be pended by providing all the required recipient and event information, that has been confirmed at 636, the purchaser indicates at 637 if he is ready to select items for the transaction, or if he wants to store the profile information to effect item selection later when he is ready to start a transaction. If the customer at 637 is ready to select items at 638 he selects and is linked to the domain of an affiliated vendor. The purchaser can then browse at 639 and see if he finds items he wants. If he does he selects the item and can browse for more from that vendor's catalog if desired. If no item or additional items are found, the purchaser can link immediately, and in one step, be back to the order pending system domain at 640. With one step at 641 the purchaser can then link from the order pending system domain to yet another affiliated e-vendor's domain while still being anchored in the transaction that was created in the order pending system. At 642 the purchaser (once linked back into the order pending domain after doing all desired browsing at affiliated e-vendor catalogs) can specify that the transaction is complete and ready for pending by the order pending system so that the parent vendors can receive reports on which of their items have been selected for future delivery. The creation of the pended transaction is completed at 643.

In addition to the representative embodiments described above, additional embodiments of the present invention may be implemented as follows: A method for executing transactions over a computer network may include the steps by which a purchaser is afforded the ability to compile and initiate an event-based transaction that is meant to be fulfilled at some time after the time that the transaction is initiated; complete that event transaction on the current date so that it is stored by an electronic order pending database for action at a specified future date; and confirm and agree to payment on or before the time the pended transaction is executed and agree that the system has authority to execute the pended transaction at the appropriate date in the future, even if no actions are taken by the purchaser at the appropriate fulfillnent time. This “basic implementation” just described could be enhanced by providing that the computer network site is controlled by any combination of the e-vendor, e-vendors, e-vendor's agents, and or the order pending system Application Service Provider. The basic implementation could also allow a purchaser to create an “Event Shopping Cart” which ties all elements of a specific transaction to a separate and distinct shopping cart for that particular event or occasion so that the cart can be revisited at any time in a way that maintains all the required transaction profile information needed to execute pended order(s) for a particular event.

The basic implementation may be enhanced by sending a prompt to the associated parent vendors prior to the dispatcher releasing a final order through the outbound router to insure that all item identifiers are current and accurate and that requested items are still available for delivery. Alternatively, or in addition to this enhancement, the basic implementation could be enhanced by providing that the administrator of the order pending database may obtain purchaser data elements at the time of obtaining the item and recipient data elements.

Further enhancements to the basic implementation of the invention are possible, such as providing that a scheduled delivery date is associated with a specific event, occasion or action that may be re-occurring at periodic intervals, The order pending system administrator may also obtain from the purchaser an indication of a next item identifier for the next occurrence of the event. The items selected by the purchaser may also or alternatively be included immediately into a transaction for pending, or may be placed in a “Personalized Browse Cart” which would store the item identifier profile information to be used at a future date by that purchaser for inclusion in one or more related or unrelated transactions.

Further enhancements to the basic implementation discussed above may include the receipt and response to electronic batch billings from e-vendors rather then business-as-usual billings for individual purchaser transactions, or the releasing of event-specific billing to purchasers for completed transactions that include payments for items from multiple and disparate e-vendors. Alternatively, or in addition to these enhancements, the implementation may provide for receiving electronic bills from the vendor for the item and a plurality of other items, and sending the electronic bills together as one bill to a purchaser for payment. The purchaser under the invention may be associated with the computer network site managed by the affiliated e-vendors or the hosting Application Service Provider. The basic implementation may provide for a preferred lead time for the item information step, e.g., that it be performed at least 3 weeks prior to the scheduled delivery date. There may also be specified lead times for the item profiling, e.g., that it be performed at least 4 weeks prior to the scheduled delivery date. Other time restrictions that may enhance the basic implementation may provide for minimum lead times for certain actions, e.g., that dispatching and routing be performed no earlier than 2 weeks prior to the scheduled delivery date. However, these time frames are variable and are based on the purchaser and/or recipient instructions applicable to each individual transaction.

The basic implementation may be enhanced by providing that the network on which it is implemented be the Internet. The system according to the invention may provide that while a purchaser is browsing an Internet web site, the purchaser be prompted or polled to provide item information including a scheduled delivery date, an item identifier, a recipient, and at least one item from the affiliated e-vendor's catalog. This information may be communicated to a related or parent e-vendor, which may be informed that the item information is to be acted on at some time closer to the scheduled delivery date. Following this, the system may be further enhanced by requiring of purchasers that an order for the selected items be submitted early enough for the parent e-vendor to ship the item to the recipient by the scheduled delivery date. At this point, the pended item information is preferably dispatched electronically as an order to the parent vendor such that the item is sent for timely receipt by the recipient no later than the scheduled delivery date. This sending step will preferably be performed at with sufficient time prior to the scheduled delivery date to meet the scheduled date based on and in accordance with vendor instructions.

As discussed above, there may be provided a prior time limit on fulfillment. For example, it may be provided that dispatching steps be performed no earlier than 1 week, or 2 weeks prior to the scheduled delivery date; however, these periods are variable based on the specific transaction instructions received. The affiliated e-vendor may be associated or a joint venturer with the remotely-hosted order pending system or may be independent, i.e., not associated. This may be implemented in conjunction with the logistic assurance aspects of the present invention discussed herein.

In a computer network having a purchaser computer system, an order pending system according to the present invention will preferably be capable of communicating with the purchaser's computer system. Any affiliated e-vendor computer system will be capable of communicating with the order pending computer system. A suitable sequence of events according to the present invention may proceed as follows: The administrator or proprietor of an order pending system may obtain at least one item for pending as selected by the purchaser through the purchaser system, the transaction to be pended will typically include at least one item and a future scheduled delivery date associated with the item. The pended order may then be stored in the order pending system database as a pended transaction. Following this, a vendor order date sufficiently prior to the scheduled delivery date to allow for delivery of the item by the delivery date may be set, followed by execution of a real-time or contemporaneous order for the items that had been pended but are not scheduled for immediate delivery. This latter method may provide that the e-vendor's system includes a computer hosted procurement, order entry and fulfillment set of systems. Typically, the step of obtaining information will provide for the prompting or retrieval for the recipient name, delivery address, and an event date. This information may be obtained from the recipient directly, or it may alternately be obtained from a purchaser.

The present invention provides for a computerized process and business methods, and accordingly contemplates an executable computer program, application, or group of applications, referred to generally herein as a “program,” or “system.” According to the present invention, a program for placing item orders will be implemented that will execute the steps, many of which have been discussed above, of obtaining an item identifier from an affiliated e-vendor's e-catalog over a computer network; obtaining a future scheduled delivery date for the item; obtaining a recipient identifier; storing the item identifier, scheduled delivery date, and recipient identifier in a pended transaction in an order pending database; waiting until the scheduled delivery date has approached; and dispatching the pended orders to the parent vendors over a computer network, wherein the pended order includes sufficient information to deliver the item(s) to the recipient no later than the scheduled delivery date. The program may also be written so as to obtain a bill for the dispatched order from the parent vendor(s), and in turn to send a bill to the purchaser's system. A further enhancement of the program according to the present invention will enable the program to obtain a purchaser profile identifying a purchaser, and sending the obtained transaction bill to the purchaser.

Software media, e.g. optical or magnetic disks, may be used to store the programs, the media providing to a computer on which the media is installed the instructions for a computer to execute the programs. A suitable computer program storage medium readable by a computer system and encoding a computer program of instructions would provide for a computerized process for placing item orders, the process having at least the following steps: the receipt of an item identifier from an affiliated e-vendor's system over a computer network, and either at that time or in the future, providing for the receipt of a scheduled delivery date for the item.

Subsequently, the identifier information and the item identifier, together with a scheduled delivery date, and recipient identifier in a order pending database may be stored. Later, when the scheduled delivery date is imminent, the pended transaction may be dispatched so that item orders are placed with the appropriate parent e-vendors over a computer network. The pended order will preferably include sufficient information to deliver the item to the item recipient no later than the scheduled delivery date.

The computer process stored on a physical software media, as described, may further have a program that may generate a bill for the dispatched order from the parent vendor. This bill may be physically mailed to the purchaser, for example, or it may be electronically transmitted. When implemented as a computer program storage medium as described herein, the computer program resident on the medium preferably will include taking control of a computer data entry session from the purchaser's system over the computer network, and may further provide for the receipt of a periodic re-occurring or recurring event indicator indicating that the scheduled delivery date is a periodic re-occurring or recurring event; and providing to a purchaser a second item identifier at about the periodic interval after the scheduled delivery date for delivery to the recipient. The computer process-generated periodic re-occurring or recurring event may pertain, for example, to an annual event, with the second transaction identifier being provided about 1 year after the original transaction identifier is received.

The methods according to the present invention can be implemented in any suitable computer language, whether interpreted or compiled. A non-limiting list of computer languages includes C, C++, Basic, Java, and Perl. The present invention includes the methods described in the present specification, computer programs implementing those methods, computer readable media storing computer programs for implementing those methods, and computer systems executing those methods and programs.

The previous discussion of the present invention is illustrative, and is not intended to in any way limit the scope of the present invention to the examples given to describe some embodiments of the present invention. The scope of the present invention is described in the claims.

What is claimed is:

1. A computerized method of doing business, comprising the steps of:
obtaining transaction information from a purchaser browsing a computer network server;
storing the transaction information until an item fulfillment date arrives, wherein the fulfillment date occurs no later than a scheduled delivery date; and
dispatching the stored item information electronically as an order to a vendor able to supply the item, such that the item is sent to the recipient no later than a time that will satisfy the item scheduled delivery date.

2. The computerized method for doing business as in claim 1, wherein the transaction information comprises at least one item scheduled delivery date, a recipient, and at least one item.

3. A computerized method for doing business as in claim 2, wherein the computer network server is controlled by the vendor.

4. A computerized method for doing business as in claim 1, wherein the computer network server is independent of the vendor.

5. A computerized method for doing business as in claim 1, further comprising the step of sending a message to the vendor prior to the dispatching step to insure there is adequate inventory to fulfill the item order.

6. A computerized method for doing business as in claim 1, further comprising obtaining payor information at the time of obtaining the item recipient identifier information.

7. A computerized method for doing business as in claim 1, where the scheduled delivery date corresponds to an event re-occurring at periodic intervals, further comprising the step of obtaining from the purchaser an indication of a next item identifier for the next occurrence of the event.

8. A computerized method for doing business as in claim 1, where the scheduled delivery date corresponds to an event re-occurring at periodic intervals, further comprising the step of obtaining from the recipient an indication of an transaction identifier for the next occurrence of the event.

9. A computerized method for doing business as in claim 1, further comprising receiving and paying an electronic bill received from the vendor.

10. A computerized method for doing business as in claim 1, further comprising receiving an electronic bill received from the vendor, and forwarding an electronic bill to the purchaser.

11. A computerized method for doing business as in claim 1, further comprising receiving electronic bills from the vendor for the item and a plurality of other items, and sending the electronic bills together as one bill to a payor for payment.

12. A computerized method for doing business as in claim 11, wherein the payor is associated with the computer network site.

13. A computerized method for doing business as in claim 1, wherein the obtaining item information step is performed at a time determined with reference to the scheduled delivery date based on a period derived from vendor lead time information.

14. A computerized method for doing business as in claim 1, wherein the obtaining item information step is performed at a time prior to the latest time that the vendor could complete delivery by the scheduled item delivery date.

15. A computerized method for doing business as in claim 1, wherein the dispatching step is performed at a time determined with reference to the scheduled delivery date based on a period derived from vendor lead time information.

16. A computerized method for doing business as in claim 1, wherein the dispatching step is performed is performed at a time determined with reference to the scheduled delivery date based on a period derived from carrier ship time information.

17. A computerized method for doing business as in claim 1, further including the step of assuring delivery via a vendor delivery assurance exchange, comprising the additional step of polling at least once the status of vendor's ability to ship through a communication exchange.

18. A computerized method for doing business as in claim 1, further including the step of assuring transaction execution by means of at least one of the following:
one or more status assurance message exchanges with at least one vendor;
arranging for an automatic alternate vendor for the item;
storing data for alternate payment sources from the purchaser.

19. A computerized method for doing business as in claim 18, wherein an alternate payment source is effected upon failure of a first payment source after permission from the purchaser.

20. A computerized method for doing business as in claim 19, wherein the alternate payment source is effected automatically upon failure of a first payment source.

21. A computerized method for doing business as in claim 17, wherein an alternate item source is determined.

22. A computerized method for doing business as in claim 21, wherein delivery by an alternate item source is automatically initiated upon notification of nonshipment by the vendor.

23. A computerized method for doing business as in claim 17, wherein the use of an alternate item source is transparent to the purchaser.

24. In a computer network having a purchaser computer system, a order pending computer system capable of communicating with the purchaser computer system, and a vendor computer system capable of communicating with the order pending computer system, a method for placing a pending transaction for at least one item, the method comprising the steps of:
obtaining at least one transaction for pending from the purchaser system, wherein the transaction includes at least one item and a future scheduled delivery date associated with the item;
pending the transaction by storing the transaction in the order pending system;
calculating a vendor ordering date sufficiently prior to the scheduled delivery date to allow for delivery of the item by the delivery date; and
executing a pended transaction order from the order pending system to the vendor system by a defined order submission date.

25. A computerized method for placing a transaction order as in claim 24, wherein the purchaser system includes a computer hosting a web site.

26. A computerized method for placing a transaction order as in claim 24, wherein the obtaining step includes obtaining recipient data and a recurring event period.

27. A computerized method for placing a transaction order as in claim 26, wherein the recipient data is obtained from the recipient.

28. A computerized method for placing a transaction order as in claim 26, wherein the recipient data is obtained from a purchaser.

29. An executable computer program for placing pended transaction orders, the computer program executing the method comprising the steps of:
obtaining at least one item identifier from a purchasing system computer over a computer network;
obtaining a future scheduled delivery date for the item;
obtaining an recipient identifier;
storing the item identifier, scheduled delivery date, and recipient identifier in an order pending database;
waiting until the scheduled delivery date is nearer in time than the date on which the item identifier was obtained; and
dispatching the pended order to a vendor over a computer network, wherein the pended order includes sufficient information to deliver the item to the recipient no later than the scheduled delivery date.

30. An executable computer program as in claim 29, further comprising obtaining a bill for the dispatched order from the vendor.

31. An executable computer program as in claim 30, further comprising sending the obtained bill to an administrator of the purchaser system.

32. An executable computer program as in claim 30, further comprising obtaining a payor identifier identifying a payor, and sending obtained charges to the payor.

33. A computer program storage medium readable by a computer system and encoding a computer program of instructions for executing a computer process in a computer system for placing item orders, the computer process comprising the steps of:
receiving at least one item identifier from a purchasing system computer over a computer network;
receiving a future scheduled delivery date for the item;
receiving a recipient identifier;
storing the item identifier, scheduled delivery date, and recipient identifier in a order pending database;
waiting until the scheduled delivery date is nearer in time than the date on which the item identifier was received; and
dispatching the pended order to a vendor over a computer network, wherein the pended order includes sufficient information to deliver the item to the recipient no later than the scheduled delivery date.

34. A computer program storage medium as in claim 33, the computer process further comprising receiving a bill for the dispatched order from the vendor.

35. A computer program storage medium as in claim 34, the computer process further comprising sending a received charge to the administrator of the purchasing system.

36. A computer program storage medium as in claim 35, wherein the computer process obtaining item identifier step includes taking control of a computer data entry session from the purchasing system over the computer network.

37. A computer program storage medium as in claim 36, the computer process further comprising receiving a periodically re-occurring event indicator indicating that the scheduled delivery date is a periodically re-occurring event; and receiving a second transaction identifier at about the periodic interval after the scheduled delivery date for delivery to the recipient.

38. A computer program storage medium as in claim 37, wherein the computer process periodic re-occurring event is an annually re-occurring event and the second item identifier is obtained at re-occurring intervals.

39. A method for doing business over a computer network comprising the steps of:
receiving a purchaser electronic purchase transaction from at least one e-vendor computer network site, wherein the transaction includes transaction information including a requested delivery date, at least one item, and a recipient;
storing the transaction in an order pending database for a time period of at least one week; and
dispatching the stored transaction information electronically as an order on an execution date to the e-vendor for delivery no later than the transaction requested delivery date.

40. A method for doing business as in claim 39, wherein the computer network site is controlled by the e-vendor.

41. A method for doing business as in claim 39, wherein the order pending database is controlled by the e-vendor.

42. A method for doing business as in claim 39, further comprising sending a query message to the e-vendor prior to the execution date to confirm that the item is available for shipment.

43. A method for doing business as in claim 39, further comprising receiving purchaser information prior to the requested fulfillment date, wherein the purchaser information includes an indicia of payment.

44. A method for doing business as in claim 39, where the requested delivery date is a re-occurring event occurring at predefined periodic intervals, further comprising the step of receiving an indication of a next transaction for the next occurrence of the event or occasion.

45. A method for doing business as in claim 39, further comprising receiving and paying an electronic bill received from the e-vendor.

46. A computerized method for doing business as in claim 43, further comprising generating a remittance to the purchaser for the transaction.

47. A computerized method for doing business as in claim 39, further comprising receiving batch electronic billings from a plurality of e-vendors for a plurality of items.

48. A computerized method for doing business as in claim 39, wherein the transaction information is received at least 2 weeks prior to the requested delivery date.

49. A computerized method for doing business as in claim 39, wherein the transaction information a is received at least 3 weeks prior to the requested delivery date.

50. A computerized method for doing business as in claim 39, wherein the transaction information is received at least 3 weeks prior to the requested delivery date.

51. A computerized method for doing business as in claim 39, wherein the dispatching step is perform ed at least 2 weeks prior to the requested delivery date.

52. A computerized method for doing business as in claim 39, wherein the dispatching step is performed no earlier than 1 week prior to the requested delivery date.

53. A computerized method for doing business over the Internet comprising the steps of:
while a purchaser is browsing an Internet web site of an e-vendor, the purchaser initiating a transaction which gathers information which includes an event or occasion date, purchaser information, a recipient profile, and at least one item from the catalogs of participating e-vendors affiliated with the order pending system or the purchaser's personalized browse cart;
storing the transaction in an order pending system; then dispatching the transaction and purchaser information to at least one of the affiliated e-vendors;
querying the e-vendor for status of the item and verification of availability for fulfillment at the requested point in time in the future; and
initiating an order with the e-vendor in time for the item to be shipped for delivery as requested by the originating purchaser.

54. A computerized method for doing business as in claim 53, wherein the querying step is performed at least 2 weeks prior to the scheduled delivery date.

55. A computerized method for doing business as in claim 53, wherein the querying step is performed at least 3 weeks prior to the scheduled delivery date.

56. A computerized method for doing business as in claim 53, wherein the dispatching step is performed at a time determined with reference to the scheduled delivery date based on a period derived from vendor lead time information.

57. A computerized method for doing business as in claim 54, wherein the dispatching step is performed no earlier than 2 weeks prior to the scheduled delivery date.

58. A computerized method for doing business as in claim 53, wherein the affiliated e-vendor is associated with the order pending Internet site.

59. A computerized method for doing business as in claim 53, wherein the affiliated e-vendor is not associated with the order pending Internet site.

60. In a computer network having a purchaser computer system, an order pending computer system capable of communicating with the purchaser computer system, and a vendor computer system capable of communicating with the order pending computer system, a method for creating transactions and placing at least one order for items, the method comprising the steps of:
obtaining at least one pending transaction from the purchaser system, wherein the pending transaction includes at least one item from an available e-vendor catalog or personalized browse cart, and a future specified delivery date associated with the transaction;
storing the transaction in the order pending computer;
calculating an e-vendor order date sufficiently prior to the specified delivery date to allow for delivery of the item by the requested delivery date; and
executing an order to the e-vendor system by the required order entry date as specified by the e-vendor.

61. A method for creating transactions and placing an order as in claim 60, wherein the order pending system includes an independently hosted web site.

62. A method for creating transactions and placing an order as in claim 60, wherein the obtaining step includes obtaining a recipient name and related profile information including at least one address and identification of related events or occasions.

63. A method for creating transactions and placing an order as in claim 62, wherein the recipient name and related profile information is obtained directly from the purchaser by input into a profile contained in the order pending system.

64. A method for creating transactions and placing an order as in claim 62, wherein the recipient name and related profile information is obtained from an approved database for which the purchaser has access and can port the information electronically.

65. An executable computer program for placing orders, the computer program executing the method comprising the steps of:
obtaining at least one item identifier from a purchaser's computer over a computer network;
obtaining a future delivery date for the item at a point in the future;
obtaining a recipient identifier;
storing the item identifier, event or occasion date, and recipient identifier in a transaction profile that is stored in the order pending database;
pending the transaction until a specified time prior to the requested delivery date; and dispatching the pended order to the parent e-vendor(s) over a computer network, wherein the pended order includes sufficient information for the parent e-vendor to fulfill the order per the directions established by the originating purchaser.

66. An executable computer program as in claim 65, further comprising obtaining a batch generated bill for the items ordered from an affiliated vendor for a specified period.

67. An executable computer program as in claim 66, further comprising composite or collective billing to the purchaser for all items ordered in any one transaction, even if the items for that transaction come from multiple e-vendors.

68. An executable computer program as in claim 66, further comprising obtaining purchaser payment information and sending the remittance resulting from the transaction to the originating purchaser.

69. A computer program storage medium readable by a computer system and encoding a computer program of instructions for executing a computer process in a computer system for placing pended orders, the computer process comprising the steps of:
receiving at least one item identifier from a purchaser's computer over a computer network;
receiving a future delivery date for the item(s);
receiving a recipient identifier; storing the item identifier, event date, and recipient identifier in a pended transaction that is stored in a order pending database for monitoring and future scheduling and dispatching;
pending the transaction until the event date is near term; and
scheduling and dispatching the pended orders to the parent e-vendor(s) in a batch mode over a computer network, wherein the order includes sufficient information for the parent e-vendor to deliver the item to the recipient no later than the requested delivery date.

70. A computer program storage medium as in claim 69, the computer process further comprising receiving a batch bill for at least one dispatched order from the parent e-vendor.

71. A computer program storage medium as in claim 70, the computer process further comprising sending the composite billing for the complete and total transaction to the originator purchaser, even if the transaction contains items from multiple vendors.

72. A computer program storage medium as in claim 70, the computer process further comprising receiving purchaser payment information and sending the remittance resulting from the transaction to the originating purchaser.

73. A computer program storage medium as in claim 69, wherein the computer process receiving the item identifier step includes taking control of a computer data entry session from the purchaser's system over the computer network.

74. A computer program storage medium as in claim 69, the computer process further comprising receiving a periodic re-occurring event or recurring transaction indicator signaling that the event is a periodic re-occurring event or recurring transaction.

75. A computer program storage medium as in claim 37, wherein the computer process periodic re-occurring event or recurring transaction is an annually re-occurring event or recurring transaction and any modified second item selections can be obtained about 1 year after the previously executed transaction has been completed.
